(19) United States
(12) Patent Application Publication
(10) Pub. No.: US 2025/0377762 A1
(43) Pub. Date: Dec. 11, 2025

(54) MENU NAVIGATION ARRANGEMENT

(71) Applicant: Wilfred KASEKENDE, London (GB)

(72) Inventors: Wilfred KASEKENDE, London (GB); Damon Paul MILLAR, London (GB)

(21) Appl. No.: 18/877,118

(22) PCT Filed: Jun. 30, 2023
(86) PCT No.: PCT/EP2023/068070

§ 371 Date: Dec. 19, 2024

(30) Foreign Application Priority Data
Jul. 1, 2022 (GB) 2209690.3

(51) Int. Cl. G06F 3/0482; G06F 3/01; G06F 3/0488; G06F 3/16

(52) U.S. Cl. CPC G06F 3/0482; G06F 3/016; G06F 3/0488; G06F 3/167

(57) ABSTRACT

A first aspect provides a computer-implemented method for navigating through a menu, the method comprising: generating a first layer of the menu on a graphical user interface; receiving a gesture input from a user comprising a continuous non-linear gesture path, the gesture input travelling from a first input region to one or more subsequent input regions; and replacing at least a portion of the first layer of the menu with one or more subsequent layers of the menu on the graphical user interface according to the received input.

### CROSS-REFERENCE TO RELATED APPLICATION

This patent application claims priority under 35 U.S.C. § 371 to Patent Cooperation Treaty (PCT) Application No. PCT/EP2023/068070 filed Jun. 30, 2023, titled “Menu Navigation Arrangement,” which claims benefit of priority from GB Application No. 2209690.3 filed Jul. 1, 2022, both of which are hereby incorporated by reference in their entirety.

### BACKGROUND

User interfaces in the art can suffer from a number of problems. One problem is that significant amounts of screen space must be allocated to the user interface (UI), which cannot be used for other tasks. In cases where there are many options for a user to choose from, the UI may occupy most of the display, leaving less space for other content to be shown. This problem is particularly onerous in devices with very small screens such as smartwatches.

User interfaces can also require a user to look at the user interface when using it, and away from other regions of interest. User interfaces are often stateful, requiring the user to look at the user interface to know its state, for example a menu of options, or a caps lock key. Items are not always displayed in the same location, for example a “recently used program” menu will change as a user selects different programs over the course of their activity, or software keyboard predicted word. This varying position makes UIs difficult to learn, or to operate unsighted.

A screen-based keyboard may be used to input text to a program. Gestures performed on such a keyboard on a touchscreen device may be interpreted based on a path drawn by a user. Interpreted paths can be ambiguous and error-prone, requiring a user to assume the correct way to perform a gesture. In typical screen-based keyboards, no indication of a user's progress is provided to the user as they construct a gesture. This lack of guidance can result in gestures that miss or drift from the user's intention, for example the path may not be close enough to one letter to activate it, but the lack of indication means the user will not be aware of that fact.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect provides a computer-implemented method for navigating through a menu, the method comprising: generating a first layer of the menu on a graphical user interface; receiving a gesture input from a user comprising a continuous non-linear gesture path, the gesture input travelling from a first input region to one or more subsequent input regions; and replacing at least a portion of the first layer of the menu with one or more subsequent layers of the menu on the graphical user interface according to the received input.

A further aspect provides a computer-implemented method for navigating through a menu, the method comprising: generating a first layer of the menu; receiving a gesture input from a user, the gesture input travelling from a first input region to one or more subsequent input regions; and repurposing at least a portion of the first layer of the menu with one or more subsequent layers of the menu according to the received input. In an example repurposing comprises replacing.

The methods described herein may be performed by software in machine-readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any other aspects described herein.

### BRIEF DESCRIPTION OF THE DRAWINGS

Examples will be described, by way of example, with reference to the following drawings, in which:

FIG. 1 is a flow diagram showing the execution of a computer-implemented operation determined by a user interaction;

FIG. 2 is a flow diagram showing a further example of an execution of a computer-implemented operation including a summoning feature;

FIG. 3 is a flow diagram showing a further example of an execution of a computer-implemented operation including the indication of valid input regions;

FIG. 4 is a flow diagram showing a further example of an execution of a computer-implemented operation including adjustment of an input factor;

FIG. 5 is a flow diagram showing a further example of an execution of a computer-implemented operation including determination of active states;

FIG. 6 is a flow diagram showing a further example of an execution of a computer-implemented operation including the provision of additional data to the user;

FIG. 7 is a flow diagram showing a further example of an execution of a computer-implemented operation including the requirement of confirmation of execution by the user;

FIG. 8 is a flow diagram showing a further example of an execution of a computer-implemented operation including the provision of feedback to the user;

FIG. 9 is a flow diagram showing a further example of an execution of a computer-implemented operation including limiting the execution of the function according to one or more predetermined rules;

FIGS. 10a and 10b show a further example of an execution of a computer-implemented operation including an additional input method;

FIG. 11 is a flow diagram showing a further example of an execution of a computer-implemented operation including dynamic adjustment of an input threshold;

FIG. 12 shows an example user interface comprising four distinct input regions;

FIG. 13 shows another example user interface comprising a signature pattern;

FIG. 14 shows an example of a command tree;

FIG. 15 shows another example of a command tree;

FIG. 16 shows an exemplary computing system; and

FIGS. 17-25 show examples of a user interface being used to access a plurality of menu options with a single unbroken gesture.

Common reference numerals are used throughout the figures to indicate similar features.

### DETAILED DESCRIPTION

Examples are described below by way of example only. These examples represent the best ways of putting the technology into practice that are currently known to the Applicant although they are not the only ways in which this could be achieved. The description sets forth the functions of the example and the sequence of steps for constructing and operating the example. However, the same or equivalent functions and sequences may be accomplished by different examples.

There are a number of drawbacks encountered by a user when making use of a standard UI. When inputting data to a program, the UI of an alternative system on a touchscreen device may offer a dedicated sub-program, such as a screen-based keyboard. However, in order to make the keyboard legible and navigable to a user, a large amount of screen space has to be dedicated to the keyboard. This screen space may be particularly limited in the case of physically smaller devices, such as smartphones and smartwatches.

Users may also be required to physically look at their devices when using the user interface. In the case of touchscreen devices especially, there is no physical feedback when a correct or incorrect area of the screen is pressed, as the screen feels uniform throughout to the user's fingertip. This requires the user to look at the user interface to know if an action has been performed correctly, for example through the use of on-screen buttons. A number of these activators, such as digital buttons, menus, or keyboards, can only be differentiated by sight.

The activators of some alternative arrangements are also scale-dependent, so they cannot be utilised on smaller or larger screens. For example, a screen below a certain physical size would be too small to accommodate a full-size conventional keyboard as each key would be too small for a user's finger to effectively select. Attention is also required to find the UI on a screen, or for the user to know their finger position on it or relative to it.

The method provided overcomes at least some of the drawbacks inherent in existing user interfaces. There is provided by at least one example a first layer of a menu, comprising four distinct portions (interchangeably referred to as regions or segments). Some examples have a different number of portions, for example eight distinct portions. A user interacts with the first layer of the menu by selecting a first option, for example using their finger to touch the relevant portion of a touchscreen device on which the first layer of the menu is displayed. The term “layer” is used to refer to a group of user interface elements presented together and where a layer may be part of a hierarchy of layers. It is possible for one or more layers to be hidden so that while one layer is shown, remaining layers are hidden. A layer is made up of one or more regions which are regions of a user input medium. A non-exhaustive list of examples of a user input medium is: a 3D region of space, a 2D region of a touch-sensitive surface, and a 1D line.

The first and/or subsequent layers of the menu displayed to the user is referred to collectively as a “command stick” (CS). The use of a consistently-mapped CS removes the need for a user to memorize multiple layouts across different platforms and/or screen sizes. Further, screen space during the operation of the menu can be re-used to provide a more efficient handling of limited screen real estate, and gestures performed across different screen arrangements are scale-free. Hence, using the CS as an input system allows a user to navigate a menu which works across multiple platforms (e.g. desktop, tablet, smartphone, smartwatch) and/or screen sizes. As a result, the user of this example is able to use the same input system across multiple platforms and screen sizes. This aids the user in becoming more proficient at using the system as they have more opportunities to strengthen their procedural memory. A user is able to create complex gestures and see what function, action, or process would be executed as a result of the gesture they created. Indications may be provided to the user while they perform the input gesture, allowing for greater accuracy while the gesture is being input.

The command stick may be used via a touch-sensitive surface such as a touchscreen and the input gesture provided by a finger of a user. In any example provided herein, a mouse pointer, trackpad, keyboard, stylus, and/or body part of a user such as a finger may be used to provide an input gesture. Each example method provided herein may be used in conjunction with any or all other example methods provided herein. The means of providing the input gesture may be analysed and the CS may be arranged to respond accordingly. In one example, the use of a two-fingered input gesture results in a different command being executed than when a single finger is used to perform the gesture.

As the user interacts with the relevant portion of the first layer of the menu, a second layer of the menu is displayed, representing a second layer of available options to the user overlaying and replacing at least a portion of the first layer of the menu. The user, in the form of a continuous non-linear gesture path, moves their finger from the first input region to a second input region to select a relevant portion of the second layer of the menu. Once the user arrives at the relevant portion of the second layer of the menu the command listed on that portion of the second layer of the menu is executed. Alternatively, the selection of the relevant portion of the second layer of the menu leads to the display of a third layer of the menu, an execution option of which can then be selected, or alternatively an option which leads to a fourth or more subsequent layers of the menu. The number of layers of the menu available is referred to as the “navigable depth” of that particular menu.

The continuous non-linear gesture path taken by the user, optionally in the form of a continuous touch between the user's finger and a touchscreen surface, forms a signature pattern. For example, if a user were to select a left hand option in a first layer of a menu, followed by an lower option in a second layer of the menu, and finally a right option in a third layer of the menu, the gesture path would form a pattern similar to the letter “U”. Once performed several times, for example through repeated use of that series of menu options, the user becomes familiar with the CS layout and the path required to select their chosen option, and hence may no longer require the UI to guide their performance of the gesture.

In another example, a user interacts with the command stick using a mouse pointer. The arrangement of this example determines when the user's pointer is interacting with an input region, for example a portion within the first layer of the menu. Interacting with the CS comprises the user's pointer being within an input region, within a proximity threshold of an input region, and/or passing through an input region. Data is then stored relating to the input region with which the user interacted. This stored data is then used to find a function using a predetermined set of rules, and the found function is then executed.

A boundary region is an area within which the user can begin a gesture with which to interact with the input system. In one example, a user can interact with the input system by engaging their mouse pointer within the input system's boundary region. When a pointer is initially engaged within the input system's boundary region, the input system will check if the user's pointer is interacting with an input region. An input region can be defined as a region within the input system's boundary region, and/or as being within an angle threshold while also being beyond a distance threshold relative to the centre of the input system's boundary region. If the user's pointer is interacting with an input region, data relating to the input region is stored. Stored data is used to find a function, which is then executed.

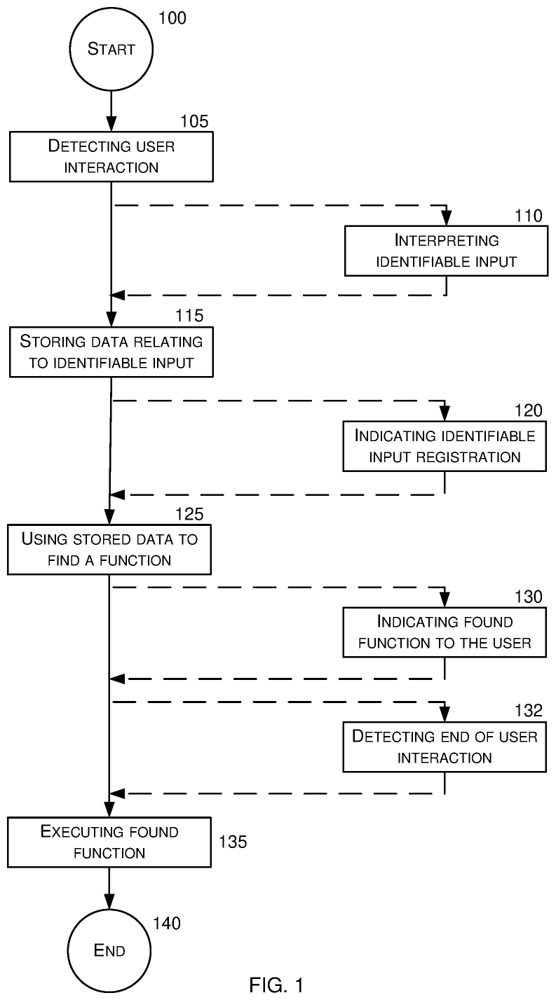

FIG. 1 is a flow diagram showing an example of the execution of a computer-implemented operation 100 determined by a user interaction. In this example, a user interacts with an input system. An input is detected 105 and identified 110, and data relating to the input is stored 115 when the user: moves their pointer beyond a threshold; or performs an identifiable gesture; or performs part of an identifiable gesture; or moves their pointer into an identifiable region; or moves their pointer through an identifiable region; or moves their pointer within a threshold of an identifiable region; or positions their pointer within an identifiable angle threshold; or accelerates their pointer beyond a threshold; or moves their device beyond a threshold; or moves their device into an identifiable region; or rotates their device beyond a threshold; or moves a representation of their device into an identifiable region or threshold.

An identifiable input is registered 120, and at least one stored input data is used 125 to find a function or action or process. At least one function or action or process is indicated 130 to the user. The end of the user interaction is then detected 132, and at least one stored input data is used to find a function or action or process which is executed 135 as a result of the user no longer interacting 140 with the input system.

In one example, the user performs a gesture in at least one predefined region in two-dimensional (2D) or three-dimensional (3D) space to provide an identifiable input, using at least one predefined threshold to interpret the identifiable input. The predefined threshold may be provided by a user and/or a developer of the CS itself. The input regions of the CS are arranged to register at least one identifiable input of a 2D or 3D input gesture provided by the user, using input regions in 2D or 3D space as required. The use of such malleable input regions allows for the CS to be adaptable to a wide range of platforms, screen sizes, and/or use case scenarios.

Some alternative gesture systems do not indicate which function would be executed when a gesture is constructed. This lack of information creates confusion and makes it harder for a user to explore a gesture system.

There is provided herein at least one example which includes a method indicating the function with which the registered inputs correspond. In this method, a user interacts with an input system, at least one input is registered, and at least one data relating to an input is stored. The stored registered inputs are used to find a function or process. An identifier of the found function or process is indicated to the user. As a result, the user is able to see which function or process their constructed gesture corresponds with. As the user constructs the input gesture the corresponding function is presented to the user as the constructed gesture changes.

In some alternative arrangements, no indication is provided to a user when an input has been registered during the construction of a gesture, which leads to uncertainty. This uncertainty makes it harder for the user to improve their execution speed and build procedural memory. Therefore, there is provided a method for indicating input registration. In this method, a user interacts with an input system and at least one input is registered. An indication of the registered input is provided to the user by one or more of: visually updating an aspect of the input system; providing the user with haptic feedback; and/or providing the user with a specific amount of haptic based on the registered input. As a result, as the user uses the system constant feedback is provided to the user to inform them about the inputs which have been registered. The user is able to determine exactly when an input has been registered and perform a gesture with greater precision. Interacting with different thresholds or regions may result in the user experiencing varying levels of haptic feedback. Alternatively or additionally, audio feedback may be used in one or more of the same use cases as haptic feedback.

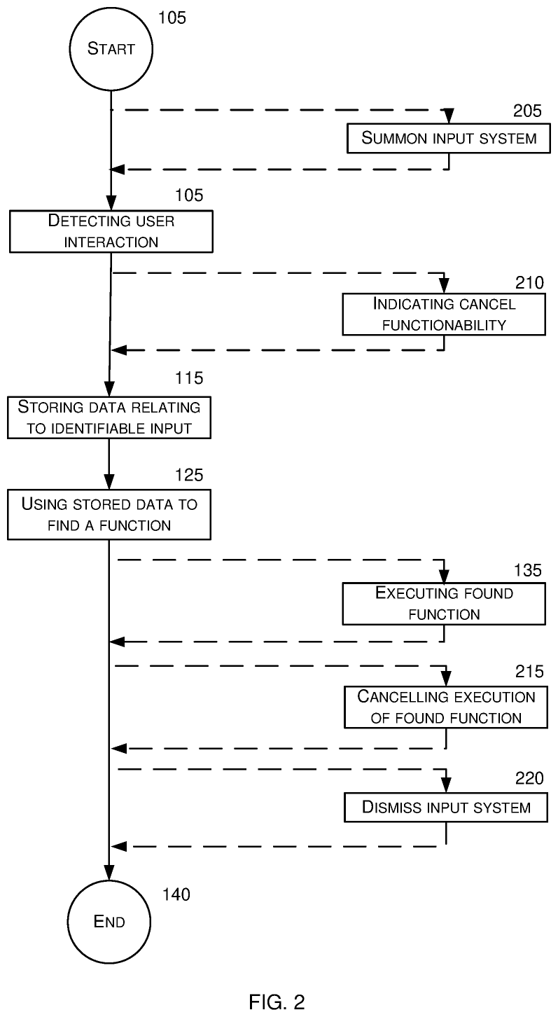

FIG. 2 is a flow diagram showing a further example of an execution of a computer-implemented operation including a summoning feature. If an input system was fixed in a location within a screen, the user would have to navigate to it to interact with it. The process of navigating to an input system that may be anywhere on the screen is difficult for a user to build procedural memory around, owing to a lack of repetitiveness in the required motion. The initial destination of a pointer can vary greatly within a screen and across different screen sizes. Even if a user is able to form a procedural memory of a command gesture, they will be unable to perform that gesture without looking at the screen to ascertain where the boundaried region is, and hence where the gesture must begin. The user would have to look at the screen in order to find the UI, so there would be no advantage to using procedural memory to make the rest of the UI operable unsighted.

There is provided in this example a method for summoning an input system. In this method, a user interacts with a device. The user performs a: double tap; or double click; or performs another predetermined action (e.g. a gesture) to move the input system's location to the location of the double tap or double click or a user's pointer location, which is referred to as “summoning” 205.

As a result, the user is able to save the time that would have been spent navigating to an input system. The user is also able to interact with the input system from a predictable state and location, so identical summon and gestures movement can be performed regardless of the UI's original position. The identical movements allow users to more effectively use and strengthen their procedural memory. A user is able to interact with the input system, then efficiently reposition the input system and execute another function, accessing the input system from a preferred position. There may further be provided a means of distinguishing between gestures and summoning commands, for example by making the summoning gesture a “double tap” input, which is not used within a gesture. Further, a first input, such as double tapping the middle circle of the CS may be set to toggle function sets provided by the CS. Double tapping outside the middle circle may be linked to a different command to send the CS to a different location on the screen, optionally a former location. In one example, if a user double clicks/taps the CS a list is shown. In this list the user can scroll through different functions and receive visual and/or haptic indications of how to perform the functions.

In at least one example, being able to summon an input system to a location within a screen can lead to the input system itself, such as the CS, blocking a user's region of interest. Therefore, there is provided a method for dismissing the input system. In this method, a user performs a predetermined input, for example one or more of: a double tap on the input system, a double click on the input system, and/or performs an action to move an input system back to its predefined origin location. This causes the input system to move away from its current location to a different location, optionally the location at which it was placed before it was summoned. This is referred to as “dismissing” the CS 220. Additionally or alternatively, the user may double tap or double click outside of an indicated cancel zone to dismiss the input system. As a result, the user is able to dismiss the input system. This prevents the input system from blocking the user's region of interest. However, the input required by the user to summon the CS, and the input required by the user to dismiss the CS, must be two different inputs. In such a way, the determination of the input is not reliant on the state of the system.

Some alternative gesture systems do not indicate what function is required by a user. They may also give the user no chance to correct incorrectly recognised gestures, owing to the constructed gesture automatically being executed upon recognition. An inability to check whether a gesture is correct and cancel it limits the amount of control and exploration which can happen within a gesture system. In one example there is provided the following method in which at least one input is registered and at least one data relating to an input is stored. The at least one stored input data is used to find a function or action or process which is executed as a result of the user no longer interacting with the input system. The input is evaluated when the user's pointer is disengaged. The execution of a found function or action or process may also occur as a result of a user clicking a button or performing an action. The registered input data would be used to determine which function is currently selected. As a result, a user is able to construct and execute a complex gesture with a single finger or pointer.

In some alternative arrangements, gesture systems typically execute gestures as they are recognised. The immediate execution, as well as the lack of information about what function or process will be performed as a result of constructing the gesture, can lead to incorrect functions being executed, causing confusion for the user. Therefore in one example a method is provided for preventing a constructed gesture from being executed immediately.

In this method, a user interacts with an input system and at least one input is registered and at least one data relating to an input is stored. A function or action or process is only executed when a user disengages the input system. As a result, the user is able to construct a gesture and cancel its execution. This allows the user to explore different gestures without being concerned about accidental function execution.

It is beneficial to provide an input system which is compact and hence requires the use of less screen space, which can be a very limited resource on some electronic devices. Requiring multiple buttons, regions or thresholds can limit the input system's utility and integrability.

Therefore, there is provided a method providing additional functionality. In this method, a user interacts with a device, and, using at least one predefined region in 2D/3D space to interpret an identifiable input; or using at least one predefined threshold to interpret an identifiable input; or using at least one predefined recognisable gesture segment to interpret an identifiable input stores data relating to an identifiable input. This example includes one or more of: changing how at least one predefined region in 2D/3D space is being interpreted and indicating the change in interpretation to a user; changing how at least one predefined threshold is being interpreted and indicating the change in interpretation to a user; and/or changing how at least one predefined recognisable gesture segment is being interpreted and indicating the change in interpretation to a user.

At least one stored input data is used to find a function or action or process which is executed as a result of the user no longer interacting with the input system. As a result, a number of regions or thresholds can be repurposed to indicate different functionality throughout the construction of a gesture.

It may be beneficial to indicate to a user how and when they are able to cancel the execution of a function 210. The user may find it helpful to know how and when they can cancel their constructed gesture, and not indicating such information can lead to a frustrating user experience.

Therefore, there is provided a method for cancelling a gesture. In this method, a user interacts with an input system and at least one input is registered and at least one data relating to an input is stored. The user may move their pointer within a region or within a threshold of a predefined cancel region or cancel threshold 215. The system then indicates to the user that they are interacting with the cancel region or cancel threshold. As a result, the user is able to know when they can terminate their gesture and it would result in the function of the constructed gesture not being executed.

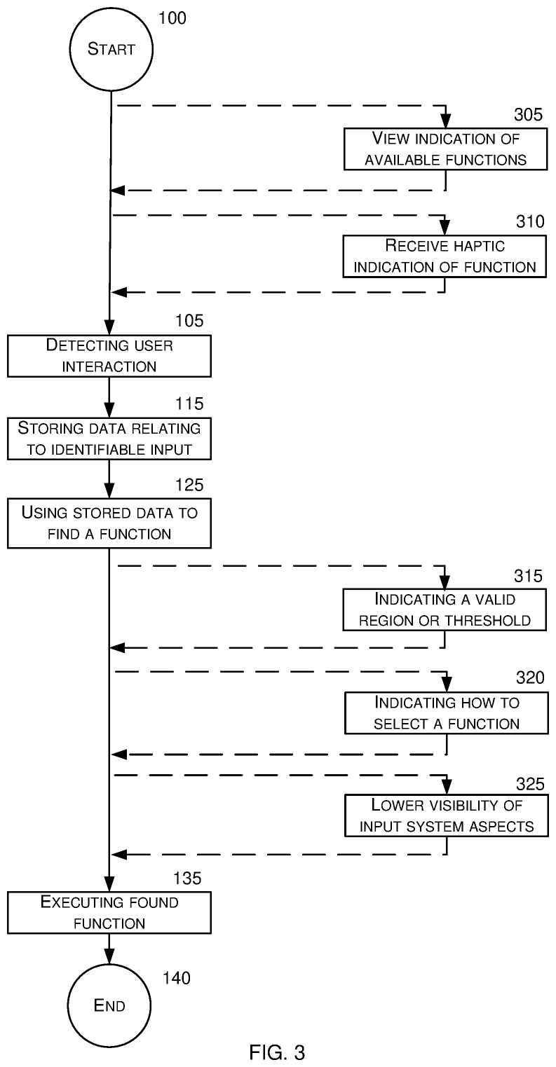

FIG. 3 is a flow diagram showing a further example of an execution of a computer-implemented operation including the indication of valid input regions. This example allows for the indication to a user regarding whether interacting with a threshold or region would result in the registered input data which correspond with a function. In some alternative arrangements, a user is unable to determine how they should construct their gesture to ensure it corresponds with a valid function.

Therefore, there is provided an example method for indicating valid threshold or regions or recognisable gesture segments. In this method, a user interacts with an input system and at least one input is registered and at least one data relating to an input is stored. At least one stored input data is used to determine if at least one threshold being interacted with or region being interacted with or recognisable gesture segment being detected would result in an input being registered and stored, that would result in stored input data that brings a user incrementally closer to a valid function. An indication of available functions is indicated 305 to the user. As a result, the user receives constant indications of how to construct valid gestures.

There is also provided an example means to efficiently communicate how to perform a particular function to the user. In some alternative arrangements, the user is unable to view the available functions and is unable to see the gesture which must be performed to execute a function.

Therefore, there is provided an example method for indicating valid threshold or regions or recognisable gesture segments. In this method, a user interacts with a list which displays indications of different functions. As the user navigates the list of functions an indication of how to construct the gesture necessary to execute a function is provided to the user. Alternatively or additionally, an indication of what constructing the gesture would feel like is also provided to the user through haptic feedback 310. A command guide can automatically be opened as a result of a user repeatedly failing to execute a gesture by cancelling its execution. As a result, the user can view the available functionality and see how to execute it.

There is also provided an example means to present the user with an indication indicating the function which would correspond with the registered input data resulting from the user interacting with a specific threshold or region or recognisable gesture segment. In some alternative arrangements, a user does not know what inputs lead to a specific function which they wish to select.

Therefore, there is provided an example method communicating how to perform the gesture corresponding with a specific function. In this method, a user interacts with an input system and at least one input is registered and at least one data relating to an input is stored. At least one stored input data is used to determine if at least one threshold being interacted with or region being interacted with or recognisable gesture segment being detected would result in an input being registered and stored, that would result in registered input data that corresponds with a valid function 315; or would result in registered input data that is incrementally closer to a valid function. There is then provided at least one indicator 320 of a function near at least one threshold or region or recognisable gesture segment if interacting with at least one threshold or at least one region or at least one recognisable gesture segment would result in registered input data that corresponds with a valid function; or registered input data that is incrementally closer to a valid function. This process may be repeated each time an input is registered.

An indication of the corresponding function or group of functions may then be provided as an icon or as text. Icons may be used to indicate a function while text may be used to indicate a group of functions. In one example, when the user selects a function, the icon which corresponds with the function grows in size or otherwise changes relative to the icons corresponding to any non-selected functions. As a result, the user receives continuous indications of what they must do to construct the gesture corresponding with a specific function. In one example, at least one aspect of the icon changes as a user's pointer is within a predefined proximity of the icon. The change in at least one aspect of the icon indicates progress towards selection. Once the selection threshold has passed, at least one aspect of the icon stops changing.

There is also provided an example method of providing a user with less guidance based on when the input system determines that the user is confident. As a user develops their procedural memory, their need for guidance and indications is reduced. Therefore, there is provided a method for conditionally removing the guidance provided to the user during the construction of a gesture. In this method, a user interacts with an input system and at least one input is registered. One or more of: the registered inputs, the time delta between at least two inputs (also referred to as “delta”), the acceleration of the user's pointer, and/or erraticness of the user's pointer is used to determine when a user is confident. When a user is determined within a predetermined boundary to be “confident”, the visibility of at least one indication which guides the user through the input system is removed or lowered 325, or the visibility of an aspect of the input system is lowered. At least one stored input data is used to find a function or action or process which is executed as a result of the user no longer interacting with the input system. As a result, the user will be able to determine their own confidence at executing a gesture based on the amount of guidance provided to them by the system. An experienced user experiences a less cluttered experience.

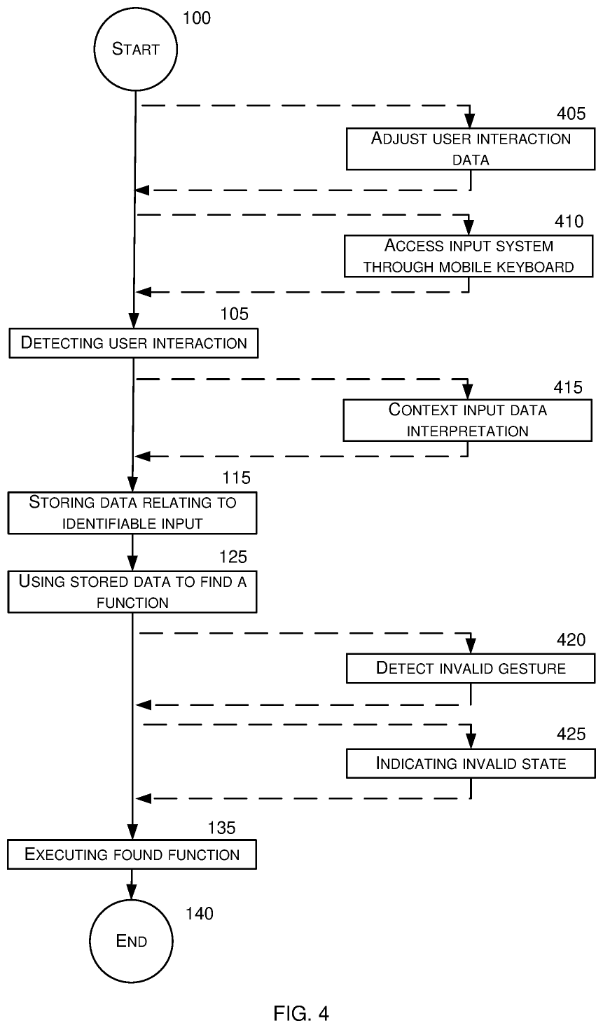

FIG. 4 is a flow diagram showing a further example of an execution of a computer-implemented operation including adjustment of an input factor, in order to maintain the validity of a user's procedural memory for gestures across multiple screen sizes and zoom levels. When a user becomes proficient at constructing gestures with an input system, they are able to construct gestures using procedural memory. The user does not need to deliberate on the movements they are making when utilising procedural memory. When the size of the input system changes due to being on a different screen size or being zoomed in, the user's procedural memory would be invalidated due to the movements necessary to complete a gesture being at the wrong scale.

Therefore, there is provided an example method for maintaining the validity of a user's procedural memory across multiple screen sizes and zoom levels. In this method, a user interacts with an input system and at least one input is registered. Different data points can be used to determine the scale factor of the input system, such as the input system's size, the zoom level of the screen, the number of dots per inch of the screen, the number of pixels per inch of the screen, and/or the size of the screen. The user input is adjusted 405 based on the input system scale factor, and/or at least one threshold size or at least one region size, and/or at least one recognisable gesture segment size is adjusted based on the input system scale factor. At least one stored input data is used to find a function or action or process which is executed as a result of the user no longer interacting with the input system.

As a result, the user is able to perform the same motion on the input system when it is zoomed in, for example at 100% or 200%, as the system will adjust the input data to maintain consistent gestures across different sizes. A user is therefore able to develop their procedural memory across different screen sizes as the sensitivity of the input system automatically is adjusted.

There is also provided an example method of allowing a user to open the input system within a touch keyboard 410. In this method, a user interacts with a touch keyboard. The user performs an action; or gesture; or clicks a button on the touch keyboard. The input system appears and is superimposed over the touch keyboard. A user interacts with an input system and at least one input is registered and stored. At least one stored input data is used to find a function or action or process which is executed as a result of the user no longer interacting with the input system. As a result, the user is able to access the input system from a touch keyboard.

There is provided an example method of actively updating which function corresponds with a gesture based on a context 415 (e.g. a selected element, or a user's pointer location), and thereby lowering the difficulty for a user to execute a function. A user may need access to different functions under different contexts.

In this example, there is provided a method for interpreting registered input data. In this method, a user interacts with an input system and at least one input is registered. The context of the system is used to determine how the registered input data should be interpreted; or the user's pointer proximity to at least one element is used to determine how the registered input data should be interpreted. At least one stored input data is used to find a function or action or process which is executed as a result of the user no longer interacting with the input system. As a result, the user can access different functions in different contexts.

It may be beneficial to allow a user to know when they need to restart their gesture. In an alternative arrangement, a user has no knowledge of when a gesture they have constructed can no longer be resolved to a valid function, which creates confusion.

Therefore, there is provided an example method indicating unresolvable and/or invalid gestures. In this method, a user interacts with an input system and at least one input is registered and at least one data relating to an input is stored. At least one stored input data is used to find a function or action or process. If no function or action or process can be found the gesture is invalid 420. The state of invalidity is indicated to the user 425. At least one previously registered input may be indicated to the user. No additional inputs are registered or stored by the input system. As a result, the user is informed when the input system has reached a state of invalidity. This allows the user to know when to restart their gesture.

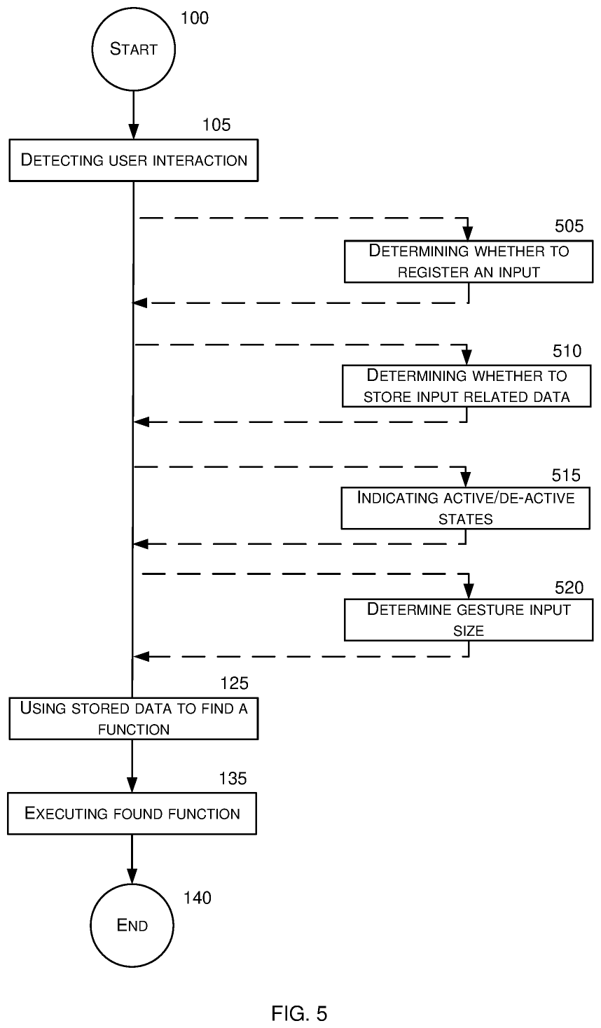

FIG. 5 is a flow diagram showing a further example of an execution of a computer-implemented operation including determination of active states. In such a way a user can be prevented from registering inputs which cannot be resolved to a valid function, thereby guiding a user towards a gesture which corresponds with a valid function. In some alternative arrangements, gesture systems have discoverability issues and are capable of being in a state in which a user's gesture cannot be resolved to a valid function. This makes the input system more error prone and creates confusion for the user. This leads to a scenario where a user is attempting to execute a function via gesture but the gesture they have formed cannot be resolved to a valid function.

There is therefore provided an example method reducing the error proneness of an input system. In this method, a user interacts with an input system and at least one input is registered and at least one data relating to an input is stored. At least one stored input data is used to determine whether a new input should be registered 505 and/or at least one stored input data is used to determine whether data relating to a new input should be stored 510 and/or at least one stored input data is used to determine whether a threshold, region or recognisable gesture segment interaction should be registered and/or at least one stored input data is used to determine whether a movement trail should be indicated to the user. At least one stored input data may be used to find a function or action or process which is executed as a result of the user no longer interacting with the input system.

Whether a region being interacted with, threshold being interacted with, or recognisable gesture segment being constructed would result in registered input data which brings a user incrementally closer to a valid function is indicated to a user. Ignoring at least one stored input data may be performed if the result is incrementally closer to a valid function. The active or de-active state of a region, threshold or recognisable gesture segment can be indicated 515 to a user. As a result, a user is less likely to make errors when attempting to execute a function. Gestures performed by a user may be interpreted within a predetermined margin of error, giving the user more leniency when forming a gesture. A user may be made aware of what movements would result in a gesture which corresponds with a valid function.

Alternatively or additionally, a user can be allowed to specify the scale at which the gesture they are constructing should be interpreted, thereby defining the size of the input system based on a natural threshold defined by the user. Differing gestures require a user to perform excursions varying in difficulty. Some gestures are more ergonomic and user friendly to perform at a smaller scale. Therefore, there is provided a method specifying the size of the input system as a gesture is constructed. In this method, at least one aspect of an incomplete gesture is used to change the scale at which at least one input is interpreted and/or at least one aspect of an incomplete gesture is used to change the size of at least one aspect of the input system 520. As a result, the user may perform the gesture at a scale most comfortable or suitable to them, optionally choosing the speed of a smaller gesture or the legibility of a larger gesture.

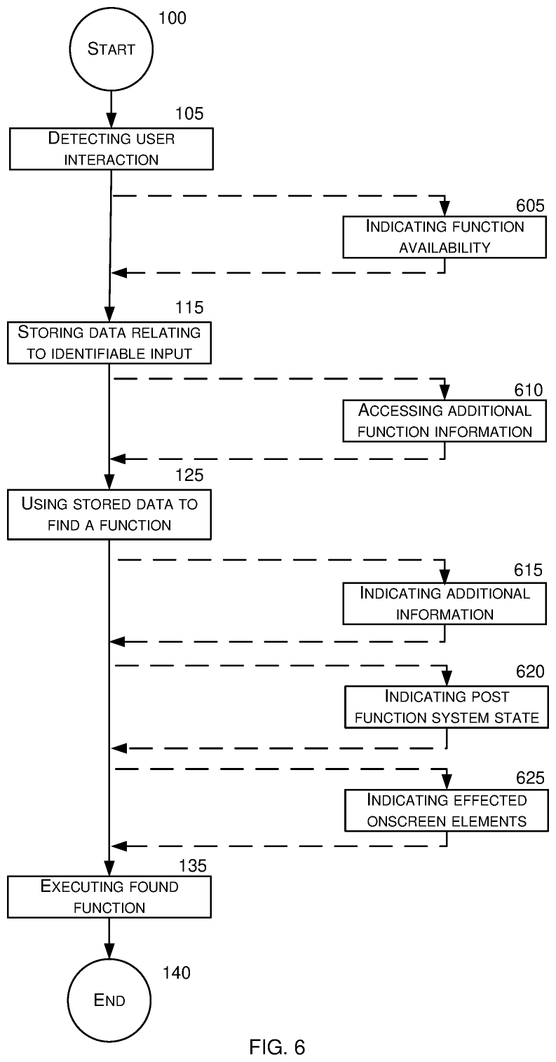

FIG. 6 is a flow diagram showing a further example of an execution of a computer-implemented operation including the provision of additional data to the user. It is beneficial to provide the user with additional data which will help them decide whether to execute a command or not, for example when making an online purchase.

In some alternative arrangements, a user cannot execute a query, evaluate the result of the query and execute a function within a single gesture. Therefore, there is provided an example method for providing information to a user as they construct a gesture. In this method, a user interacts with an input system and at least one input is registered and at least one data relating to an input is stored. At least one stored input data is used to find a function or action or process. The function or process is used to determine 610 what additional information needs to be indicated to the user 615, which is then indicated to the user.

The user can then determine whether to execute the found function based on the additional information presented to the user. As a result, the user is able to see additional information which helps them determine whether they should execute a function.

It is beneficial to communicate to the user what the result of executing a gesture's function will be. In some alternative arrangements, when a user constructs a gesture, they are unable to see what the result of executing the gesture's function would be. Therefore, there is provided an example method for providing a preview of the result of executing a gesture's function. In this method, a user interacts with an input system and at least one input is registered and at least one data relating to an input is stored. At least one stored input data is used to find a function or action or process. A preview of the functionality of the found function or process is indicated 620 to the user. As a result, the user is able to see additional information 625 which helps them determine whether they should execute a gesture's function. For example, when the user constructs the “zoom in” gesture, there is displayed a preview of what the zoomed in state would be.

In one example, the arrangement can provide the user with a method of obtaining additional information or guidance during the construction of their gesture. In some alternative arrangements, during the construction of a gesture a user needs additional information which helps them make a better informed decision about what action to perform next.

Therefore, there is provided a method for toggling additional information display during the construction of a gesture. In this method, a user interacts with an input system and at least one input is registered. The user moves their pointer into a designated threshold or region, and/or tilts their device to increase the visibility of additional information. The additional information may indicate if the resulting registered input data would correspond with function and/or a group of functions. As a result, the user is able to toggle additional information mid gesture which can assist them in determining what input needs to be registered for them to construct a gesture which corresponds with a desired function. This example method may include accessing additional information through translating or rotating a device beyond a predetermined threshold, by performing a gesture, and/or by moving a user's pointer beyond a threshold. The user can adjust the amount of guidance provided by the system as they are constructing a gesture.

Communicating function availability to the user helps to avoid confusion. In some alternative arrangements it may not be possible to execute a function while a system or process is in a specific state. A user being unaware of this can lead to them believing the system is unresponsive or broken. Therefore there is provided a method for communicating function availability 605. In this method, a user interacts with an input system and at least one input is registered and at least one data relating to an input is stored. At least one stored input data is used to find a function or action or process. At least one validity check is executed for the found function or action or process.

If the validity check determines that the found function is unavailable under the current circumstances, the unavailability of the found function is indicated to the user. Alternatively or additionally, haptic feedback could be provided to the user to indicate that the function they have selected, or might select, is unavailable under the current circumstances. The haptic indication would be provided when the user attempts to execute a function. Indication may be provided to the user as to why a function is unavailable after the user attempts to execute a function which has been indicated to be unavailable.

Haptic feedback could be used to indicate whether the user has selected a function. Haptic feedback may be used to differentiate gestures which correlate with functions and groups. As a result, a user can be informed of a function being unavailable prior to them executing it. This helps to reduce confusion that the system is functioning correctly and is not broken. When a user executes a function which is indicated to be unavailable, they then receive additional indications that the function was not executed.

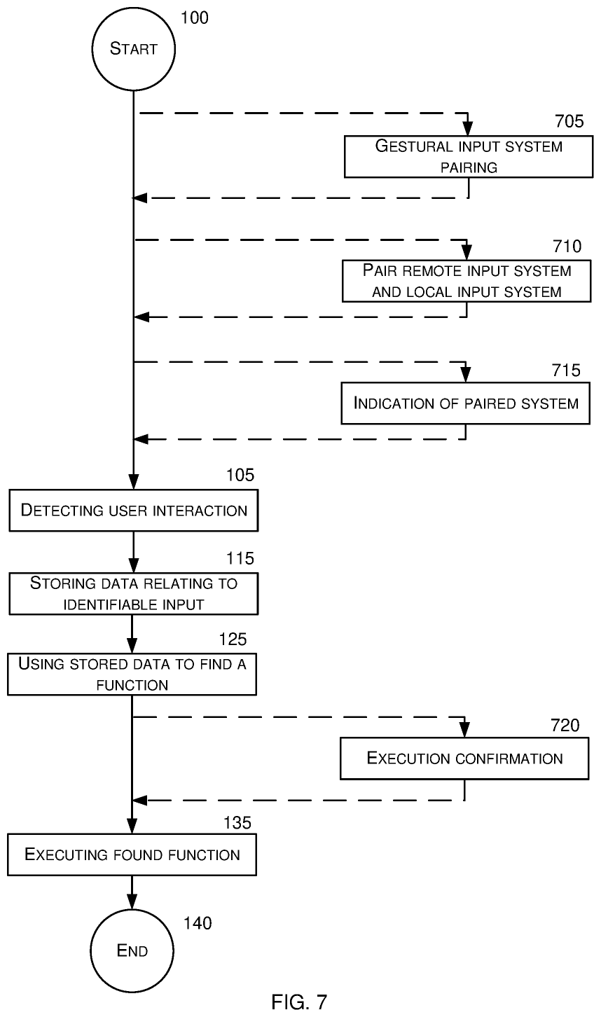

FIG. 7 is a flow diagram showing a further example of an execution of a computer-implemented operation including the requirement of confirmation of execution by the user. In one example, a user is provided with a chance to confirm the execution of a function. In some alternative arrangements, gesture-based systems do not provide opportunities for a user to confirm the execution of the function which corresponds with a gesture. This limits the use cases for gesture based inputs.

Therefore, there is provided a method for requesting confirmation prior to executing a function. In this method, a user interacts with an input system and at least one input is registered. At least one stored input data is used to find a function or action or process which is executed as a result of the user no longer interacting with the input system. Prior to the found function or action or process being executed, the user is requested to confirm 720 that they intend to execute the found function or action or process. As a result, the user has additional control over the functions which will be executed.

In some examples, there is provided a method to allow a user to remotely pair and control a system 705 via the input system. In some alternative arrangements a user would have to directly interface with the system, which limits its utility. Therefore, there is provided a method for using a remote input system. In this method, a user pairs a remote input system to a local input system 710. At least one data is received on the remote input system relating to at least one input which relates to a specific function. An indication 715 that the remote system is paired to the local system is shown. After pairing with a local input system, inputs from a remote input system whilst the local input system is being interacted with are to be ignored. The arrangement may indicate on a local input system that the inputs being displayed are from a remote input system. The arrangement may indicate on a local input system that a remote input system is sending inputs. As a result, the user is able to pair and explore the functionality available on different remote input systems.

It may be beneficial to provide a user with remote gesture execution functionality. Requiring a user to be in close proximity to the system which is receiving gesture inputs prevents the user from making the most out of their procedural memory. Therefore, there is provided an example method for pairing and executing functions on a remote device. In this method, a local device's input system indicates a gesture which must be performed on a remote device's input system to pair the two input systems together. The user performs the pairing gesture and the input systems are paired together. After pairing, a function which corresponds to a gesture constructed on the remote device's input system will be executed on the local device's input system. As a result, the user can remotely connect to different device's input systems, and execute functions on them. Executing or performing a function or gesture may result in the input system issuing functions to a different system or application. Pairing may be achieved through NFC, QR Code, and/or registering a specific input.

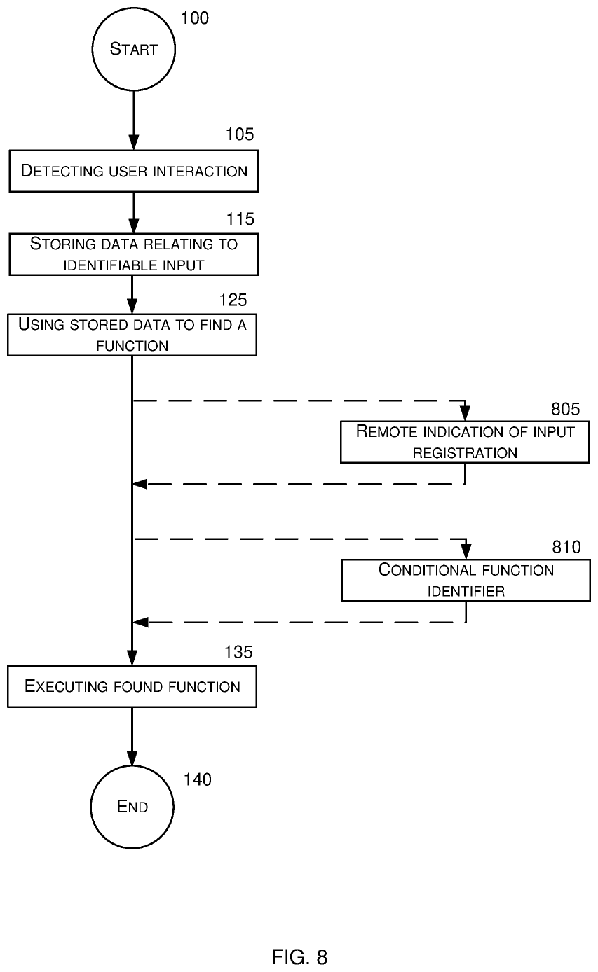

FIG. 8 is a flow diagram showing a further example of an execution of a computer-implemented operation including the provision of feedback to the user. It may be beneficial to provide the user with additional feedback when constructing a gesture. Some alternative arrangements, such as desktop computer mice, trackpads, and keyboards, may not offer haptic feedback. This limits the amount of feedback a user can receive while executing a gesture. This lack of feedback lowers a user's accuracy at discerning the different registered inputs within a gesture.

Therefore, there is provided a method for providing additional feedback while constructing a gesture. In this method, a user interacts with an input system and at least one input is registered and at least one data relating to an input is stored. A remote electronic device, such as a smartwatch or remote smartphone, provides the user with feedback 805, optionally in the form of visual and/or haptic and/or audible feedback, as a result of a new input being registered or stored. As a result, the user is able receive feedback across multiple platforms.

It may be beneficial to provide a user with a dynamic function name based on the internal state of a system 810. In some alternative arrangements, static function names can result in additional functions needing to be added to the system to reflect the different functions available. For example, the functions “Turn On Light” and “Turn Off Light” are provided as the result of separate gestures.

Therefore, there is provided a method for communicating dynamic functions' functionality to the user. In this method, a user interacts with an input system and at least one input is registered and at least one data relating to an input is stored. At least one stored input data is used to find a function or action or process. An indication of the found function is provided to the user. The indication of the found function provided to the user varies based on the state of an internal or remote system. The found function is executed as a result of the user no longer interacting with the input system. As a result, the user is able to see varying indications of what a function would do based on the internal state of a system.

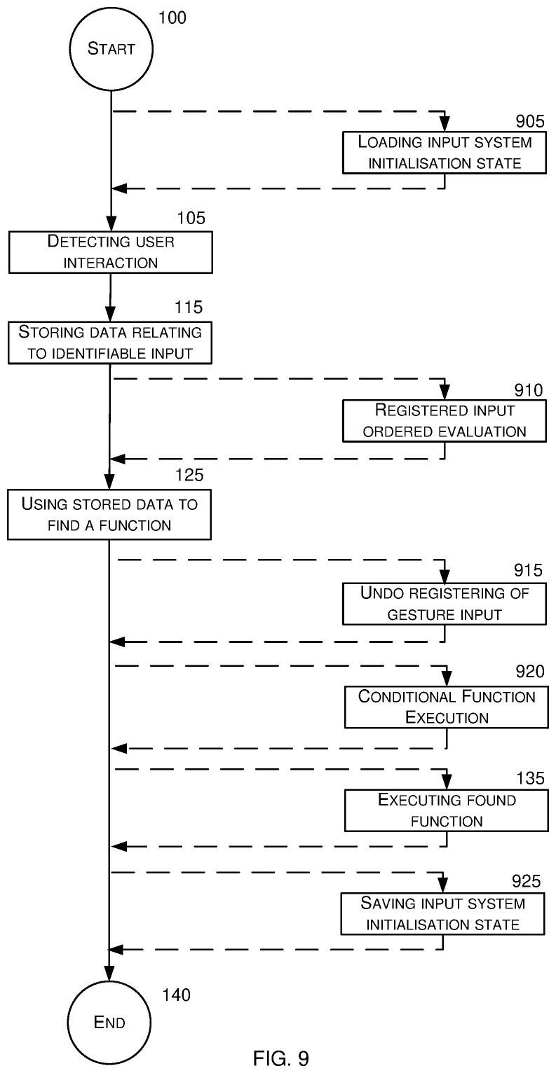

FIG. 9 is a flow diagram showing a further example of an execution of a computer-implemented operation including limiting the execution of the function according to one or more predetermined rules. Not letting the order influence the function limits the number of different functions which can be constructed with a set of inputs. In some examples, the order in which inputs appear in the stored registered data set is used to determine what function to execute.

Therefore, there is provided a method for determining the function which corresponds with a set of registered inputs. In this method, a user interacts with an input system and at least one input is registered and at least one data relating to an input is stored. The order in which data appears in the stored registered input data is used to find a function or action or process. As a result, the user is able to construct a wider variety of gestures with minimal differentiation between them. For example, the gesture “up down” can correspond with the “Focus” function, and the gesture “down up” can correspond with the “Fit” function.

In some examples, it is beneficial to communicate function availability to the user to avoid confusion. There are scenarios in which a function should not be executed, for example zooming beyond a predetermined threshold. Therefore, there is provided a method for conditionally executing a function 920. In this method, a user interacts with an input system and at least one input is registered and at least one data relating to an input is stored. At least one stored input data is used to find a function or action or process. At least one validity check is executed for the found function or action or process. If the validity check determines that the function is invalid under the current circumstances, it will not be executed as a result of the user no longer interacting with the input system. As a result, a function can be designed to only execute under certain circumstances 920 and may indicate its inability to perform the function to the user.

In some examples, a user is allowed to skip specific inputs in their gesture to allow them faster access to a certain gesture's functionality. Repeatedly inputting long gestures can be considered difficult and take up the user's time. Therefore, there is provided a method for speeding up the input of a long gesture. In this method, a user interacts with an input system and at least one input is registered. A function is activated which stores the current registered input data as a shortcut 925. At least one stored input data is used to find a function or action or process which is executed as a result of the user no longer interacting with the input system 140. A function is activated which loads the stored registered input data based on the shortcut. As a result, a user can store their registered inputs and load them later. This allows them to skip registering part or all of the gesture.

In some examples, “undo” functionality is provided to the user so that they can backtrack on their previous input. As the user constructs a gesture they may accidentally register unintended inputs. Therefore, there is provided a method undoing the registering of a gesture input. In this method, a user interacts with an input system and at least one input is registered and at least one data relating to the input is stored. The user performs a gesture within a threshold or region which removes at least one data relating to a previous input from stored registered input data 915. As a result, the user is able backtrack on unintended registered inputs. Similar steps may be applied to achieve “redo” functionality.

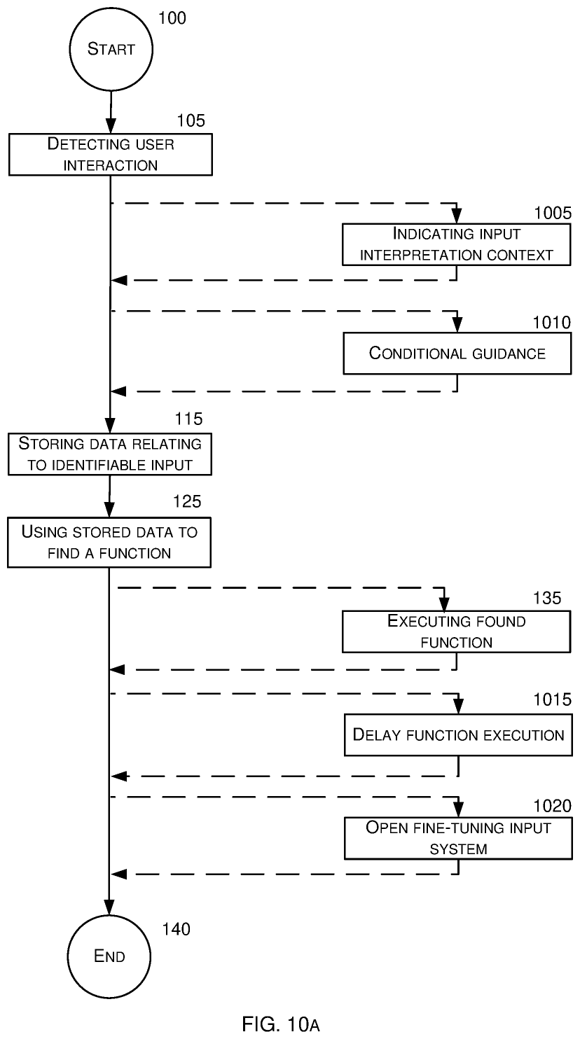

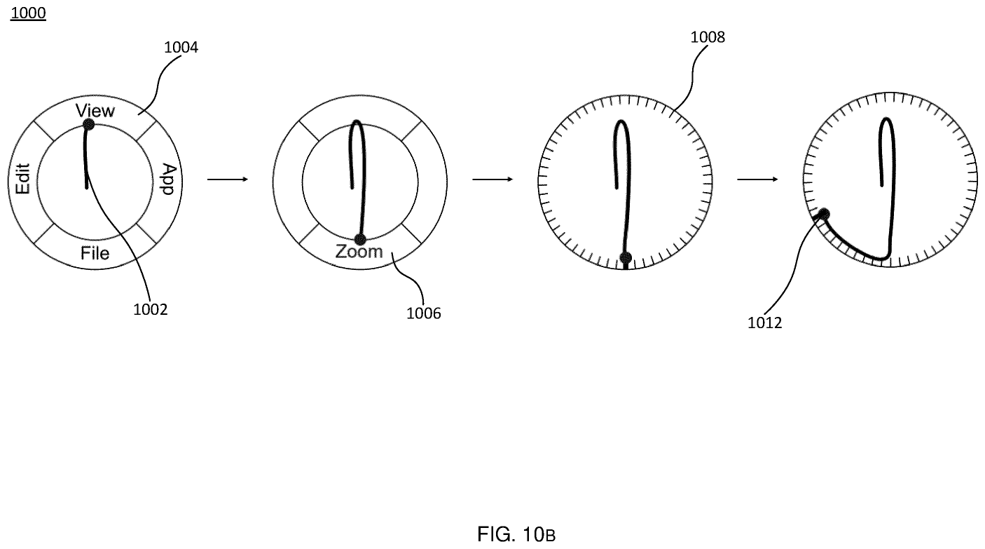

FIG. 10a is a flow diagram showing a further example of an execution of a computer-implemented operation including an additional input method. It may be beneficial to provide a user with an additional input method after executing a function. Some functions require fine-tuned adjustments, for example adjusting the volume of a device from a “three” to an “eight”. Therefore, there is provided an example method for fine-tuned parameter adjustment and/or other secondary input system. In this method, a user interacts with an input system and at least one input is registered. At least one stored input data is used to find a function or action or process which is executed as a result of the user no longer interacting with the input system. A fine-tuning interface, for example a dial, is superimposed over or placed near the input system 1020 allowing the user to adjust at least one parameter. Such a fine-tuning interface is shown in FIG. 10b. As a path 1002 is drawn on a user interface 1000, the user selects, in the first layer, the upper region 1004 which is marked “View”. The second layer of the menu is then overlaid onto the first layer, revealing, in this example, one further option for selection by the user. The user, continuing their gesture, selects the lower region 1006 of the second layer of the menu labelled “Zoom”. This causes a third layer of the menu, in the form of a fine-tuning interface 1008, to replace the second layer. The user, continuing their gesture, selects a point 1012 from the plurality of points in the fine-tuning interface 1008. The user then terminates their gesture. A function is then executed based on the final selection 1012 in the fine-tuning interface 1008 of the user, for example zooming in to a specified level on a digital display.

Alternatively or additionally, if the function selected does not have any follow on functions, the fine-tuning interface can be initiated before the user disengages the input system. This allows the user to select the fine-tuning function and adjust it with a single motion. As a result, the user is provided with an appropriate user interface for the task at hand.

It may be beneficial to provide a user with an indication of under what context the registered input data will be evaluated. A user not knowing what context the gestures they construct are being interpreted under can create confusion. Therefore, there is provided an example method for indicating the context under which registered input data is interpreted. Such an interpretation may include a command of “undo object movement” or “undo entered text”. In this method, a user interacts with an input system and at least one input is registered. An indication is provided to the user 1005 which indicates under what context the registered input data is being interpreted. At least one stored input data is used to find a function or action or process which is executed as a result of the user no longer interacting with the input system. As a result, the user has additional control over the functions which will be executed.

It may be beneficial to provide a user with indications which provide them with guidance based on when the input system determines that the user is hesitating 1010. Constantly providing the user with additional guidance can lead to a cluttered user interface. Therefore, there is provided an example method for conditionally providing guidance to the user during the construction of a gesture, when their hesitance suggests displaying the information would be helpful. In this method, a user interacts with an input system and at least one input is registered. One or more of: the registered inputs; the time between at least two inputs (also referred to as “delta”); the acceleration of the user's pointer; and/or the erraticness of the user's pointer, is used to determine when a user is hesitating. When a user is hesitating, at least one additional indication may be provided which guides the user through the input system. At least one stored input data is used to find a function or action or process which is executed as a result of the user no longer interacting with the input system. As a result, a less confident user will automatically be provided with additional guidance during the construction of a gesture.

It may be beneficial to provide a user with a chance to delay or cancel the execution of a function. Alternative gesture systems may not provide opportunities for a user to cancel the execution of the function which corresponds with a gesture which has been performed. This limits the use cases for gesture based inputs. Therefore, there is provided an example method for providing a cancellation window prior to executing a function. In this method, a user interacts with an input system and at least one input is registered. At least one stored input data is used to find a function or action or process which is executed as a result of the user no longer interacting with the input system. Prior to the found function or action or process being executed a user must wait a predefined amount of time 1015. During the predefined amount of time the user can cancel the execution of the function. As a result, the user has additional control over the functions which will be executed.

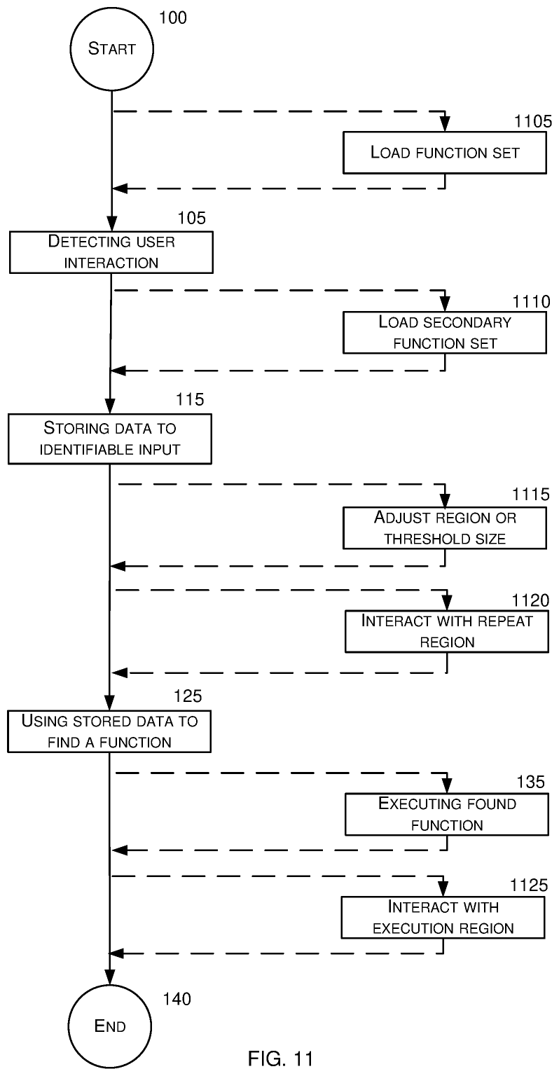

FIG. 11 is a flow diagram showing a further example of an execution of a computer-implemented operation including dynamic adjustment of an input threshold. It is beneficial to allow a user to switch between different function sets, enabling them to access additional functions. As in some alternative arrangements, indicating all the available functions within an input system to the user is problematic owing to the limited number of groups which can be displayed at once.

There is therefore provided an example method in which a function set is loaded 1105, comprising data relating to at least one function and at least one input. A user performs an action which loads a secondary function set 1110, for example loading a specific program onto the electronic device being used by the first function set. The user interacts with the input system and at least one input is registered. At least one stored input data and at least one function set is used to find a function or action or process which is executed as a result of the user no longer interacting with the input system.

In some examples, the user can switch function sets by double tapping or triple tapping the input system, or by pressing and holding down a particular region of a menu or activating any momentary input method. An indication of the amount of available function sets is provided to the user. The input system may determine which function set to switch to based on the amount of fingers a user uses to initially interact with the system. In some examples, a user can switch function sets by interacting with the interface with two fingers or by using the right and left mouse buttons. As a result of one or more of these examples, the user may be able to more efficiently access additional functions. Different functions may be accessed by the same gesture, depending on the function set that is loaded. This allows a user to utilise their procedural memory across multiple functions.

It may be beneficial to dynamically adjust the form of the thresholds or regions during the construction of a gesture to make it easier for a user to complete the next step of a gesture. As a user performs a gesture they may struggle with specific dexterous movements. This increases the likelihood they will register an accidental input. Therefore, there is provided an example method for making it easier for a user to register specific inputs. In this method, a user interacts with an input system and at least one input is registered. The input system uses the registered input data to determine at least one region or threshold which if adjusted in size 1115 may make it easier for a user to register an input which would result in registered input data that corresponds with a valid function; or would result in registered input data that is incrementally closer to a valid function. At least one stored input data is used to find a function or action or process which is executed as a result of the user no longer interacting with the input system. As a result, the user will perform fewer mistakes while using the input system.

It may be beneficial to allow a user to execute the function which corresponds with their constructed gesture without disengaging the input system. In some alternative arrangements, a user has to disengage the input system to execute the function which corresponds with their constructed gesture. Therefore, there is provided an example method for executing a function without disengaging the input system. In this method, a user interacts with an input system and at least one input is registered and at least one data relating to an input is stored. At least one registered input data is used to find a function or action or process which is executed when a user's pointer is within a predefined threshold or region. As a result, the user is able to execute a function without ending their gesture. Mid gesture function execution allows a user to execute multiple functions within one gesture.

It may be beneficial to allow a user to rapidly execute a function which corresponds with their previously constructed gesture. In some alternative arrangements a user has to construct a full gesture multiple times to execute a function multiple times. Therefore, there is provided an example method for rapidly executing function. In this method, the user interacts with an input system and at least one input is registered and at least one data relating to an input is stored. At least one stored input data is used to find a function or action or process which is executed as a result of the user no longer interacting with the input system. The registered input data is saved. When the user's pointer is within a predefined threshold or region or interacts with a predefined recognisable gesture segment the last executed gesture's registered input data is loaded. Additionally or alternatively, a “repeat” function could be predefined. The functionality corresponding with the “repeat” function would be the “previously executed” gesture's function 1120. As a result, the user is able load the previously executed function's registered input data, saving them time in constructing a gesture. The currently selected function can be executed through interacting with the “execution region” 1125.

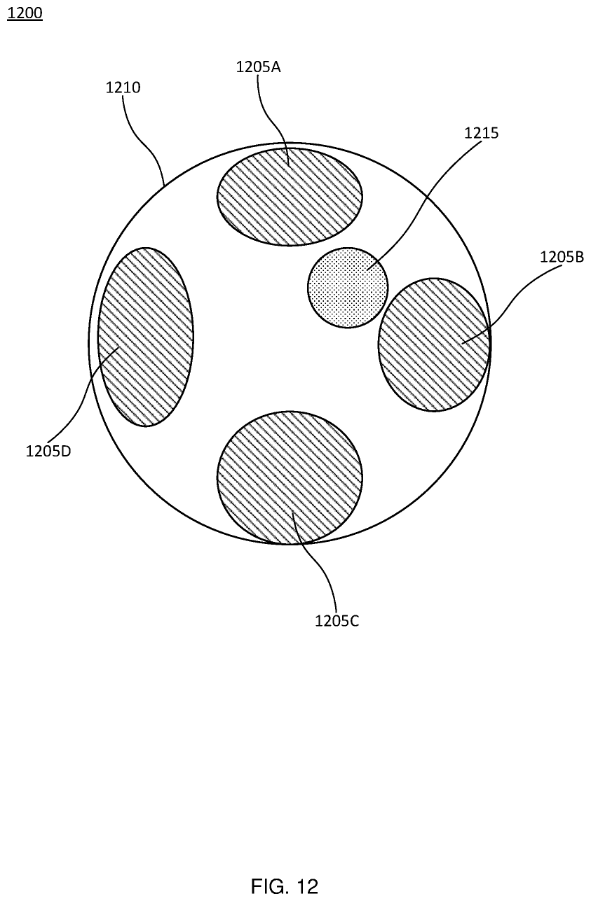

FIG. 12 shows an example user interface of a CS 1200 comprising four distinct input regions 1205A-D. This user interface is designed to receive a complex gesture input system which recognises inputs based on thresholds. When a user engages the CS with their pointer or other input arrangement, there may be provided to the user an indication as to which inputs they can register to result in registered input data that corresponds with a function. By moving their pointer within a threshold (e.g. 55%-99% distance threshold) the input corresponding to the threshold and angle is registered. The registered input data is used to find and display a function corresponding to the registered input data. When a user goes beyond a certain threshold (e.g. 99% distance threshold) function labels for the next stage of the gesture are shown. This allows a user to see which inputs they can register which would result in registered input data that corresponds with a specific function. When a user disengages their pointer, the registered input data is used to determine which function should be executed. If there is a function which corresponds with the registered input data it is executed. If the user disengages their pointer within a threshold (e.g. 0-5% distance threshold) the function corresponding to the registered input data may be executed.

In the example shown in this figure, the CS is surrounded by an instruction region 1210. A gesture being within this threshold allows the CS to indicate which additional inputs a user would need to register to result in registered input data that corresponds with a specific function. Each of the four input regions 1205A-D are operable to register and store an input when it is entered by the user. If a user disengages the CS within a threshold of a cancel region 1215 the function corresponding to the registered input data is not executed. Optionally, there is provided a movement region, and when the user is within this region the CS does not register or store an input. In one example, the cancellation of a gesture can be calculated by extrapolating a gesture velocity. If the user gestures in a predetermined direction at a predetermined velocity, and terminates their gesture in the direction of the cancel zone, the selected function is not executed. This threshold allows the user to easily navigate to different input regions.

The circular arrangement of this figure is just an example, and it is appreciated that other layouts may be used within the bounds of this method, for example a linear layout or a layout comprising a series of concentric regions.

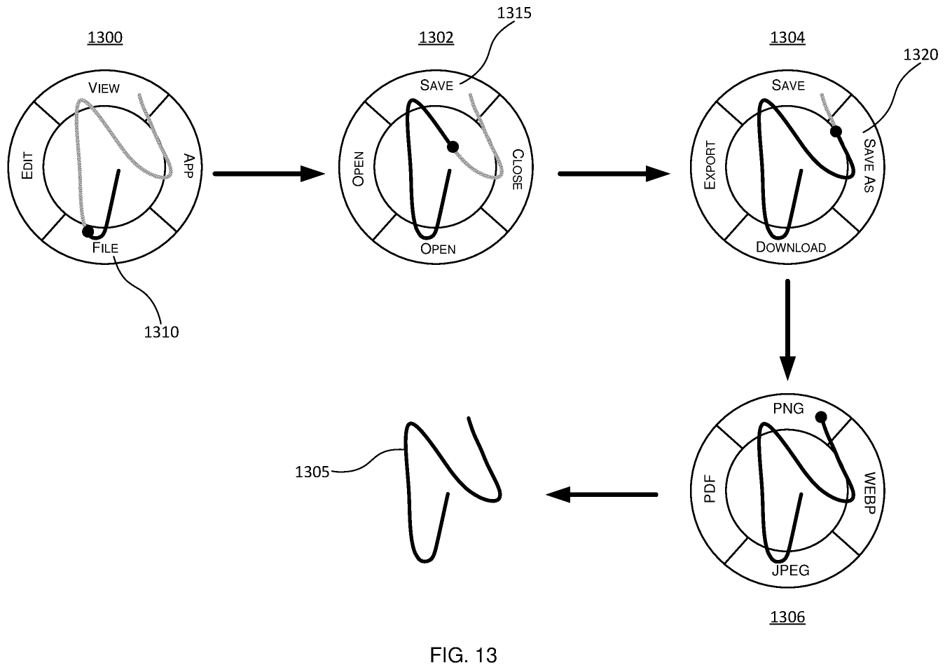

FIG. 13 shows another example user interface comprising a signature pattern formed by the use of a gesture path 1305. This figure represents the changes apparent in the navigable first menu of the CS between a novice and a more experienced user. In this example, the user requires a function located in a fourth layer of a series of menus. The user selects, in the first layer 1300, the lower region 1310 which is marked “File”. The second layer of the menu 1302 is then overlaid onto the first layer 1300, revealing one or more further options for selection by the user. The user, continuing their gesture, selects the upper region 1315 of the second layer 1302 of the menu marked “Save”, causing a third layer 1304 of the menu to be overlaid to the second layer 1302, revealing one or more further options for selection by the user. The user, continuing their gesture, selects the right hand region 1320 marked “Save As” of the third layer 1304 of the menu. This causes a fourth layer 1306 of the menu to be overlaid to the third layer 1304, revealing one or more further options for selection by the user. Finally, the user, continuing their gesture, selects the upper region 1315 marked “PNG” of the fourth layer 1306 of the menu, and terminates their gesture. A function is then executed based on the final selection of the user in the fourth layer 1306 of the menu.

Initially, the navigable UI is apparent, allowing a user to learn the steps required to perform an action. Once an action has been learned, the apparent UI is no longer required, allowing the user to simply perform the gesture when they require a particular action. The gesture path 1305 taken by the user, if repeated sufficiently, becomes a familiar movement. In due course, the user can repeat the gesture path 1305 without the guidance of the CS, or even a visible menu at all, in order to execute their desired function. Optionally, the desired path and user path are shown to the user at the completion of their gesture, so the user is able to see how their command gesture may be improved or optimised.

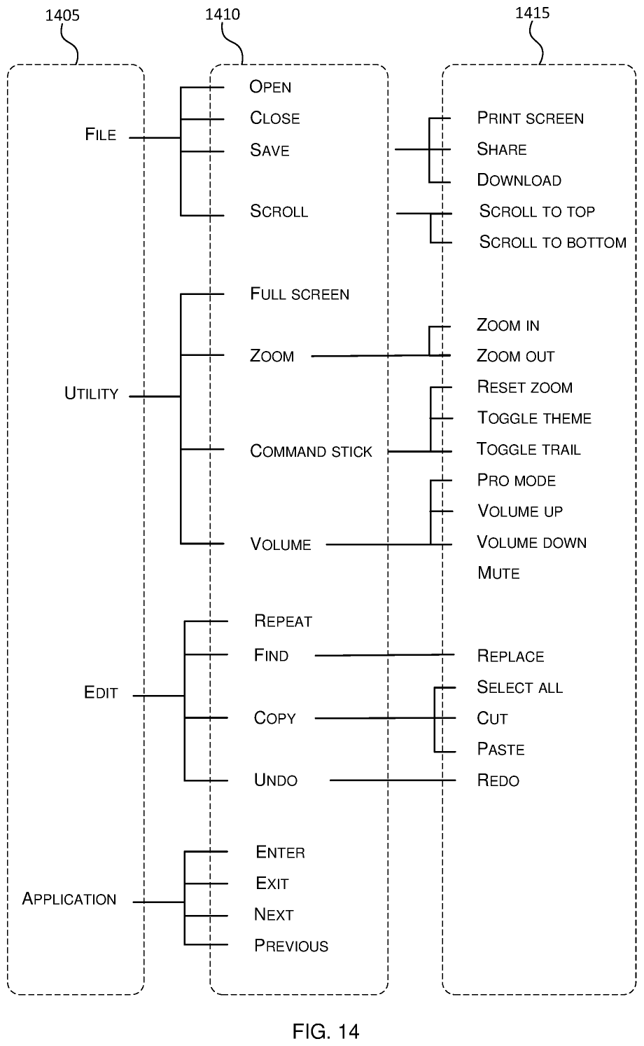

FIG. 14 shows an example of a command tree. In this figure, there is provided a menu with a navigable depth of three. The first layer of the menu 1405, for example that displayed on the four separate regions of the circular user interface such as that of FIG. 13, shows to the user four options: “File”, “Utility”, “Edit”, and “Application”. The selection of the first option, “File”, causes a second layer of the menu 1410 to be displayed over the first layer of the menu. The second layer 1410 of the menu displays four new options, “Open”, “Close”, “Save”, and “Scroll”. If the user selects one of the first two options, “Open” or “Close”, then the selected function is then executed based on the final selection of the user, who terminates the gesture without any further layers of the menu being opened or displayed.

If, however, the user selects one of the other two options, “Save” or “Scroll”, then a third and final layer 1415 of the menu is displayed over the second layer 1410 of the menu. If the user selected “Save” in the second layer 1410, then three further options are displayed in this third layer 1415: “Print Screen”, “Share”, and “Download”. If the user selects one of these three options, then the selected function is then executed based on the final selection of the user, who terminates the gesture without any further layers of the menu being opened or displayed. Alternatively, if the user selected “Scroll” in the second layer 1410, then only two further options are displayed in this third layer 1415: “Scroll to Top” and “Scroll to Bottom”. If the user selects one of these two options, then the selected function is then executed based on the final selection of the user, who terminates the gesture without any further layers of the menu being opened or displayed.

Similarly, if the user were to have selected a different option in the first layer 1405 of the menu, for example the option “Utility”, then a different second layer 1410 of menu options would be displayed, which then leads to a different layer 1415 of third menu options being displayed and/or different functions being executed.

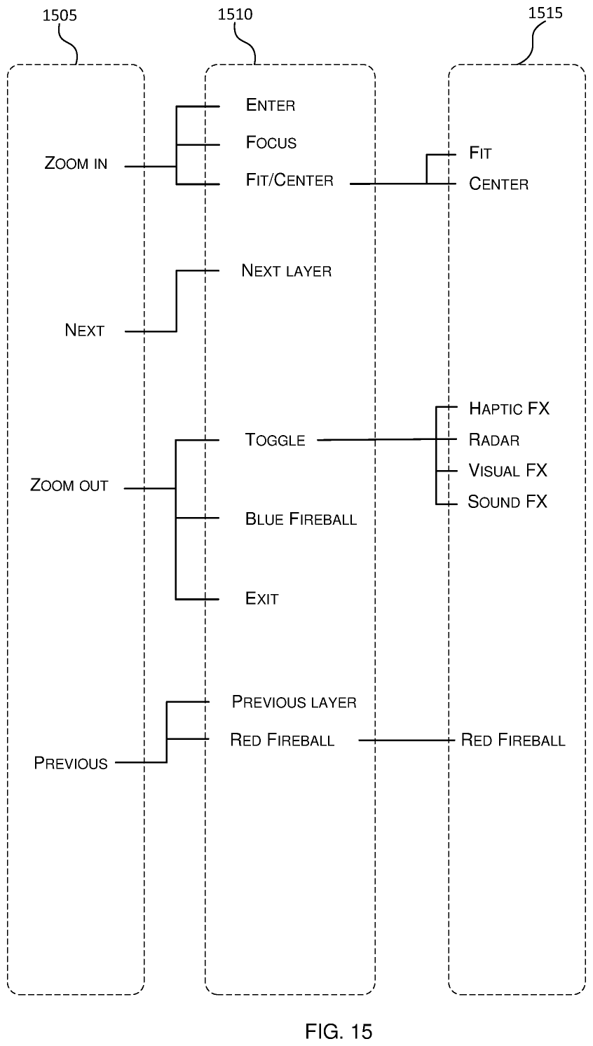

FIG. 15 shows another example of a command tree, also with a navigable depth of three, in which a different menu is navigated from that of the preceding example. Such a menu may be used in a different setting, for example when a user has a specific program open on their computer which is to be navigated using this alternative menu. Alternatively or additionally, the user can switch menus at will according to their own personal preferences.

In this figure, the first layer 1505 of the menu, for example that displayed on the four separate regions of the circular user interface such as that of FIG. 13, shows to the user four options: “Zoom In”, “Next”, “Zoom Out”, and “Previous”. The selection of the first option, “Zoom In”, causes a second layer 1510 of the menu to be displayed over the first layer 1505 of the menu. The second layer 1510 of the menu displays three new options, “Enter”, “Focus”, and “Fit/Center”. If the user selects one of the first two options, “Enter” or “Focus”, then the selected function is then executed based on the final selection of the user, who terminates the gesture without any further layers of the menu being opened or displayed. If, however, the user selects the third option, “Fit/Center”, then a third and final layer 1515 of the menu is displayed over the second layer 1510 of the menu. This third layer 1515 displays two further options, “Fit” and “Center”. If the user selects one of these two options, then the selected function is then executed based on the final selection of the user, who terminates the gesture without any further layers of the menu being opened or displayed.

Similarly, if the user were to have selected a different option in the first layer 1505 of the menu, for example the option “Zoom Out”, then a different second layer 1510 of menu options would be displayed, which leads to a different third layer 1515 of menu options being displayed and/or different functions being executed.

It may be beneficial to allow a user to know which onscreen element is the current focus of the input system. In some alternative arrangements, it is not clear which onscreen element(s) a function a user is executing is affecting. Therefore, there is provided a method for indicating the affected on screen elements. In this method, the user interacts with an input system and at least one input is registered. At least one stored input data is used to find a function or action or process which is executed as a result of the user no longer interacting with the input system. Upon initiating a gesture or selecting a function an indication of at least one onscreen element which would be affected by the found function is provided to the user. As a result, the user is better informed of the elements which would be affected by a selected command.

It may be beneficial to allow a user to interact with the input system without having their finger, or other input device, occlude the input system's user interface. In an alternative arrangement, interacting with an input system via a touch screen can lead to scenarios where a user's finger occludes their vision of user interface elements. Therefore, there is provided an example method interacting with the input device without occluding a user's view of the user interface: In this method, a user interacts with a device using a touch surface remote from the display screen of the device, for example: on the back of the device; using a folded touch screen on the back of the device; and/or using a secondary touch screen on the back of the device. The input system is displayed to the user on a front screen. A user interacts with an input system and at least one input is registered. At least one stored input data is used to find a function or action or process which is executed as a result of the user no longer interacting with the input system. In one example, an indication is provided to the user near their finger or pointer. As the user's finger or pointer approaches a selectable item within the input system, the provided indication changes. Once a user selects a selectable item the indication near their finger may change to indicate which selectable item was selected.

In one example, the arrangement is configured to receive at least one data relating to a user input, and adjust at least one user input data to locate the data user input within the boundaries of the input system. In this example, an indication of the user's pointer position within the input system is provided on the front screen. The front screen displays the state of the input system as the user navigates through the menu by interacting with a remote touch surface. The remote touch surface may be housed within a mobile phone or a wrist strap which is connected to a smartwatch. As a result, the user is able to interact with the input system without having their finger occlude their view of the input system's user interface.

In some examples, it may be beneficial to prevent accidental activations of the input system via a remote and/or local touch surface. In some alternative arrangements, accessing the input system via a surface located on the back of a device leads to accidental activations of the input system. In the case of a remote touch surface, there is provided a method for activating the input system on the remote touch surface. In this method, a user performs a gesture or action (e.g. double tap) on a touch surface on the back of a device; or a folded touch screen on the back of the device; or a secondary touch screen on the back of the device. As a result, the input system is activated. The user interacts with the input system and at least one input is registered. At least one stored input data is used to find a function or action or process which is executed as a result of the user no longer interacting with the input system. The input system may be displayed on the front screen after the activation gesture/action is performed. In one example, only the touch area in proximity to the initialisation point of the user's activation gesture or action would be active. The inputs outside of the proximity of the initialisation point in this example are ignored, for example in the case of rejection of an input when the palm of the user accidentally makes contact with the remote surface during a gesture performed with their finger.

The arrangement then uses the initialisation point of the user's activation gesture to interpret at least one data user input data. An indication may be provided to a user indicating that the remote touch surface is active, for example via haptic feedback and/or a visual indicator. Alternatively or additionally, a remote touch surface of the device may be deactivated in response to a gesture being executed. As a result, the user is able to interact with the input system without having their finger occlude their view of the input system's user interface.

It may be beneficial to allow a user to more efficiently navigate the available functions and improve the user's recall of a function in gesture space. Having gestures which are similar in form but not related in functionality makes it harder for a user to remember them. Therefore, there is provided an example method for improving the recall of a function. In this method, a user interacts with an input system and at least one input is registered and at least one data relating to an input is stored. At least one group label is presented to a user which provides an indication of at least one available function which could be selected as a result of the user interacting with at least one threshold or interacting with at least one region or by registering a recognisable gesture segment. At least one stored input data is used to find a function or action or process which is executed as a result of the user no longer interacting with the input system. As a result, the user is able to discern the available functionality without manually checking different gesture paths. The user can memorise the locations of groups of functionality instead of having to memorise the location of individual functions.

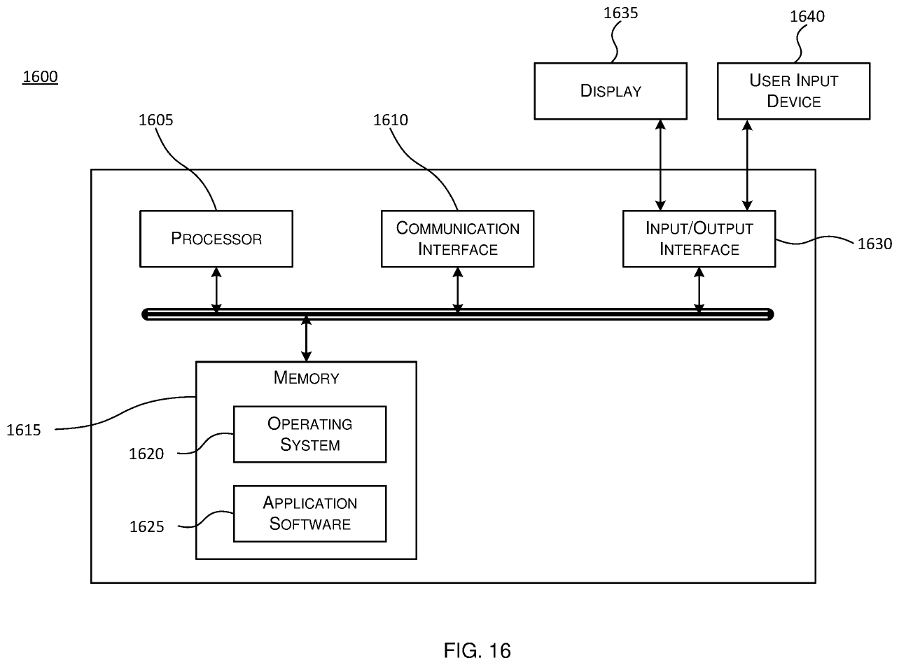

It is appreciated that aspects may be implemented on any form of a computing and/or electronic device, such as that shown in FIG. 16. A computing-based device 1600 comprises one or more processors 1605 which may be microprocessors, controllers or any other suitable type of processors for processing computer executable instructions to control the operation of the device in order to perform the method as described. In some examples, for example where a system on a chip architecture is used, the processors may include one or more fixed function blocks (also referred to as accelerators) which implement a part of the method as described in hardware (rather than software or firmware). Platform software comprising an operating system 1620 or any other suitable platform software may be provided at the computing-based device to enable application software 1625 to be executed on the device.

The computer executable instructions may be provided using any computer-readable media that is accessible by computing based device. Computer-readable media may include, for example, computer storage media such as memory 1615 and communications media. Computer storage media, such as memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory) of one example is located within the computing-based device it will be appreciated that the storage may be distributed or located remotely and accessed via a network or other communication link (e.g. using communication interface 1610).

The computing-based device also comprises an input/output controller 1630 arranged to output display information to a display device 1635 which may be separate from or integral to the computing-based device. The input/output controller is also arranged to receive and process input from one or more devices, such as a user input device 1640 (e.g. a mouse or a keyboard). This user input may be used to perform the method as described. In some examples the display device may also act as the user input device if it is a touch sensitive display device. The input/output controller may also output data to devices other than the display device, e.g. a locally connected printing device.

The term “computer” is used herein to refer to any device with processing capability such that it can execute instructions. Those skilled in the art will realize that such processing capabilities are incorporated into many different devices and therefore the term computer includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Alternatively or additionally, there is provided an embodiment, optionally used in conjunction with any other embodiment described herein, which allows a user to efficiently make fine-tune adjustments to multiple parameters without requiring additional screen space for multiple fine-tuning interfaces. Alternative fine-tune interfaces either require a dedicated amount of space for each parameter you intend to adjust with a fine-tuning interface, or are cumbersome and slow to change a parameter which a fine-tuning interface is adjusting.

To overcome the drawbacks of said alternative fine-tune interfaces there is provided herein a method for changing a parameter which is being adjusted by a fine-tune interface. In this method, a user interacts with a fine-tuning interface and adjusts a first parameter. The first parameter which was adjusted is then changed to a second parameter when a user performs one or more of the following actions:
moves their pointer outside of an identifiable region;
exits an identifiable region from a predetermined angle;
performs a gesture within an identifiable region of the fine-tune interface;
moves their pointer through an identifiable region of the fine-tune interface;
moves their pointer into and out of an identifiable region of the fine-tune interface and the path traversed within the identifiable region is determined to meet a threshold of linearity;
dwells within a threshold for a predetermined amount of time;
swipes towards the centre of an angular based fine-tune interface and outwards from the centre of an angular based fine-tune interface;
swipes towards the centre of an angular based fine-tune interface and outwards from the centre of an angular based fine-tune interface, within a degree threshold of an angular based fine-tune interface;
swipes towards the centre of an angular based fine-tune interface and outwards from the centre of an angular based fine-tune interface, within a degree threshold of an angular based fine-tune interface, within a predetermined time threshold;
moves their pointer within a predetermined region and moves their pointer out of a predetermined region;
moves their pointer within a predetermined region and moves their pointer out of a predetermined region, within an angular threshold;
moves their pointer within a predetermined region and moves their pointer out of a predetermined region, within a predetermined angular threshold and predetermined time threshold;
swipes inwards and outwards within a degree threshold of an angular based fine-tuning interface;
moves their pointer beyond a threshold;
performs an identifiable gesture;
performs part of an identifiable gesture;
moves their pointer into an identifiable region;
moves their pointer through an identifiable region;
moves their pointer within a threshold of an identifiable region;
positions their pointer within an identifiable angle threshold;
accelerates their pointer beyond a threshold;
moves their device beyond a threshold;
moves their device into an identifiable region;
rotates their device beyond a threshold;
moves a representation of their device into an identifiable region or threshold;
disengages their pointer;
disengages their finger;
adds an additional finger to a touch surface;
changes the orientation of a device; and/or
angles their finger within a specific threshold.

The second parameter is then be adjusted. As a result, the user can rapidly change a parameter they are adjusting using a fine-tune interface. The process of changing a parameter and adjusting a parameter can be achieved in a single motion, and the process can be repeated multiple times within a single motion. The user does not have to use multiple fine-tune interfaces or make dexterous movements to change a parameter being adjusted.

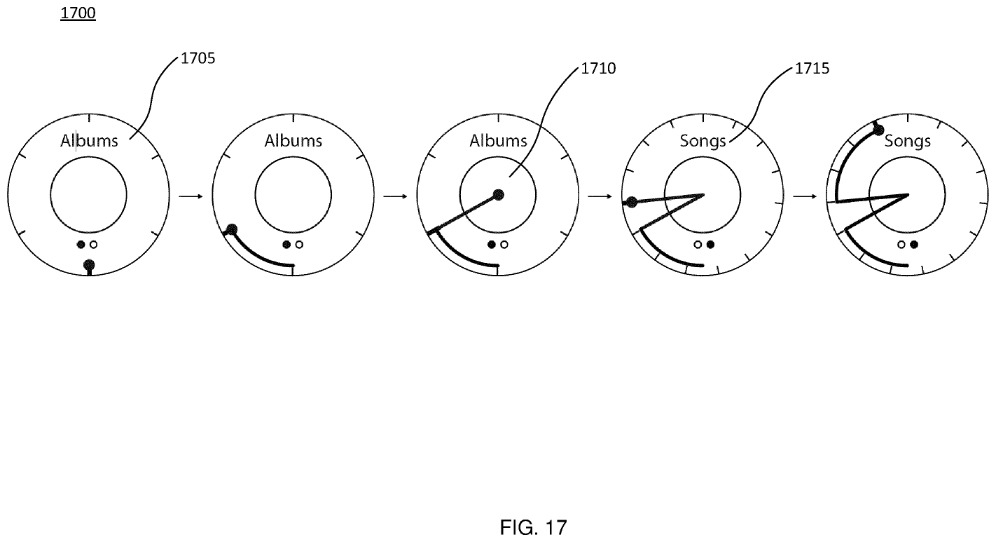

FIG. 17 shows an example user interface of a CS 1700. In this example, a user adjusts a first parameter 1705, enters and exits a predetermined region 1710 of a fine-tune interface from within a predetermined angle threshold, resulting in the parameter 1705 which is being adjusted by the fine-tune interface being changed to a second parameter 1715. The user then adjusts the second parameter 1715. Optionally, within a single motion, the user may navigate through multiple songs and then switch to changing the seek position within a song. The user may further dynamically change the granularity of snap scrolling from page level to title level to paragraph level without stopping their scrolling motion.

Optionally, an indication of the current parameter which is being adjusted is provided to the user while a user adjusts the parameter. An indication of the number of parameters which can be adjusted may also be provided to the user as a user adjusts a parameter.

Optionally, a predetermined region of the fine-tune interface is used for changing a parameter which the fine-tune interface is adjusting. This may be an inner region of an angular based fine-tune interface. A user could perform an action or gesture within this predetermined region to change a parameter which is being adjusted by the fine-tune interface. As the user interacts with the fine-tune interface, adjustments may only be made to a parameter which is being adjusted by the fine-tune interface when the fine-tune interface is being interacted with from outside of the predetermined region. The outside of the predetermined region may be used for changing the parameter which is being adjusted by the fine-tune interface.

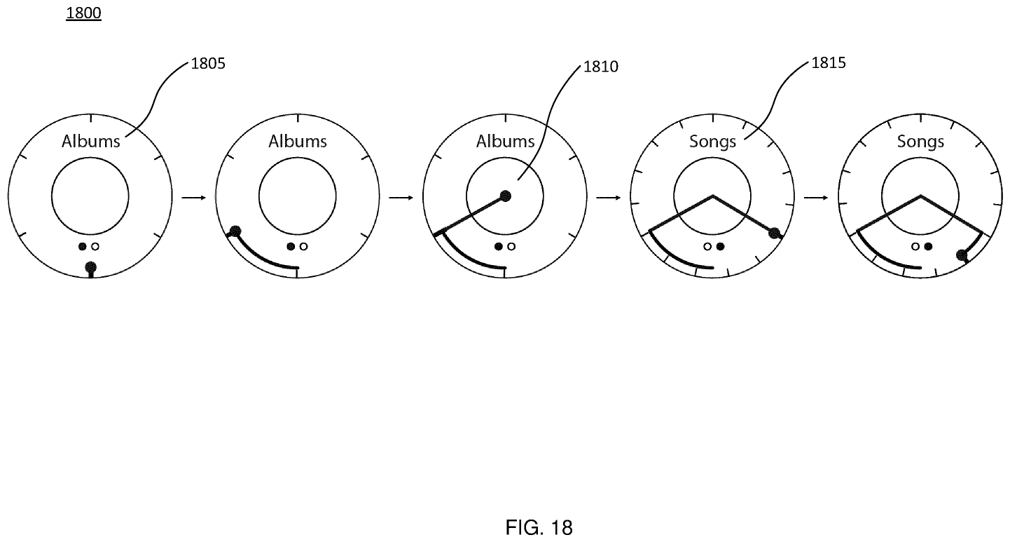

FIG. 18 shows an example user interface of a CS 1800. In this example a user adjusts a first parameter 1805, enters a predetermined region 1810 of a fine-tune interface and exits the predetermined region 1810 of a fine-tune interface from the right, resulting in the parameter in which is being adjusted by the fine-tune interface being changed to the next parameter 1815 within a predetermined set of parameters. The user then adjusts the newly selected parameter 1815.

Optionally, when a user changes from adjusting the first parameter to the second parameter the delta between at least two identifiable increments are increased to reduce the chances of a user accidentally incrementing the second parameter during the process of changing the parameter which is being adjusted by the fine-tune interface

Optionally, data relating to a current path, current trajectory, future path, and/or future trajectory of the movement of a user's cursor or pointer is used to determine if the user intends to interact with a predetermined region of the fine-tune interface. This data may be used for changing a parameter which is adjusted by the fine-tune interface. When it is determined that a user intends to interact with a predetermined region of the fine-tune interface which may be used for changing a parameter which is being adjusted by a fine-tune interface, the fine-tune interface may be set to ignore user interaction which would normally result in a parameter being adjusted.

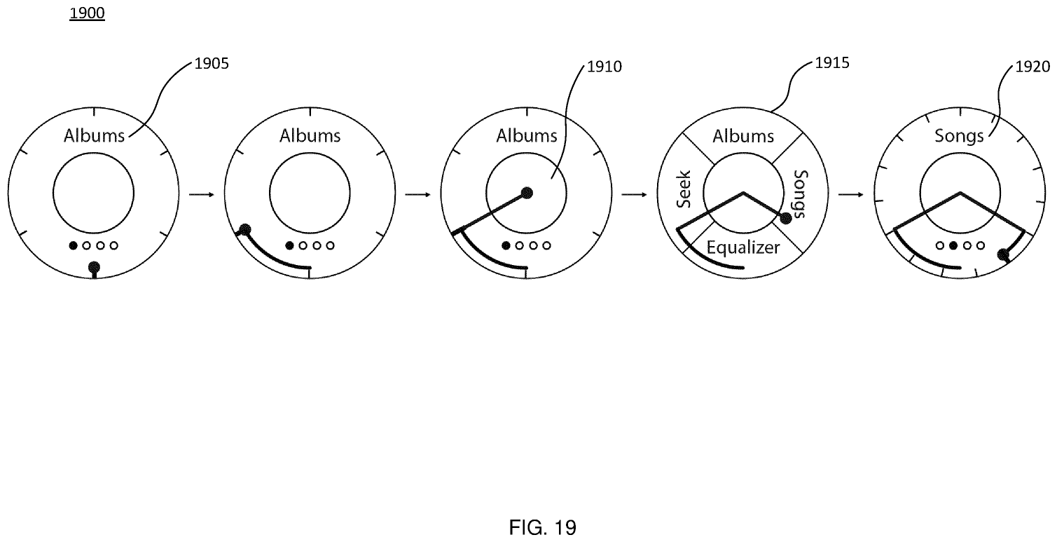

FIG. 19 shows an example user interface of a CS 1900. In this example, a user adjusts a first parameter 1905, enters a predetermined region 1910 of a fine-tune interface which causes a menu 1915 to appear and replace the first parameter 1905. The user may then select a menu item and proceed to adjust a second parameter 1920 which corresponds with the selected menu item using the fine-tune interface. This process can be repeated to adjust multiple parameters. Optionally, the menu or fine-tune interface may be invisible to the user. Optionally, haptic feedback may be provided throughout the fine-tuning and menu selection process.

Optionally, entering a predetermined region of the fine-tune interface makes the menu appear and entering another predetermined region would result in no adjustments being made to the parameter by the fine-tune interface. One or more predetermined regions may be arranged in concentric circles. Optionally, if the fine-tune interface has reduced opacity, when a user interacts with a predetermined region of the fine-tune the result is that the menu options become selectable. The fine-tune interface's opacity may then be changed.

Optionally, when a user enters the predetermined region of a fine-tune interface a menu are presented to the user which indicates at least one menu item which if selected results in a parameter which is being adjusted by the fine-tune interface being changed. When a user selects an option from the menu which appears as a result of a user entering a predetermined region within a fine-tune interface, the fine-tune interface may allow a user to adjust the newly selected parameter in a single motion. The threshold or angular threshold at which a user exits a predetermined region of the fine-tune interface may be used to determine which parameter would be adjusted by the fine-tune interface. Optionally, at least one value relating to a second parameter can be indicated to a user while the user adjusts the first parameter.

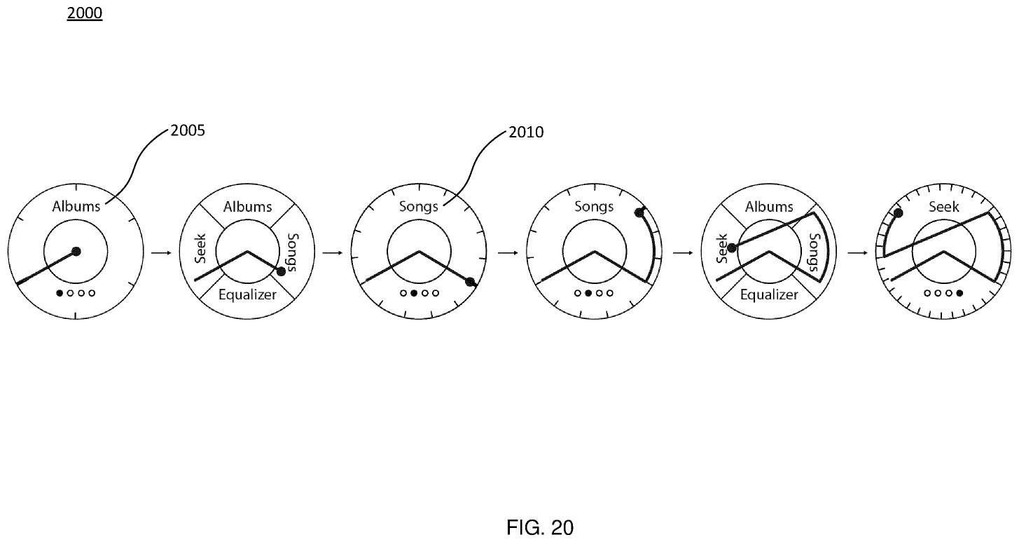

As shown in the example of FIG. 20, when a user changes from adjusting a first parameter 2005 to adjusting a second parameter 2010 with the fine-tune interface, a function which relates to the first parameter 2005 may be executed. For example, if a user is changing the parameter being adjusted from albums to songs, a selection function could be executed on the album last navigated to using the fine-tune interface. This would allow a user to browse and select multiple aspects of different parameters without disengaging the fine-tine interface.

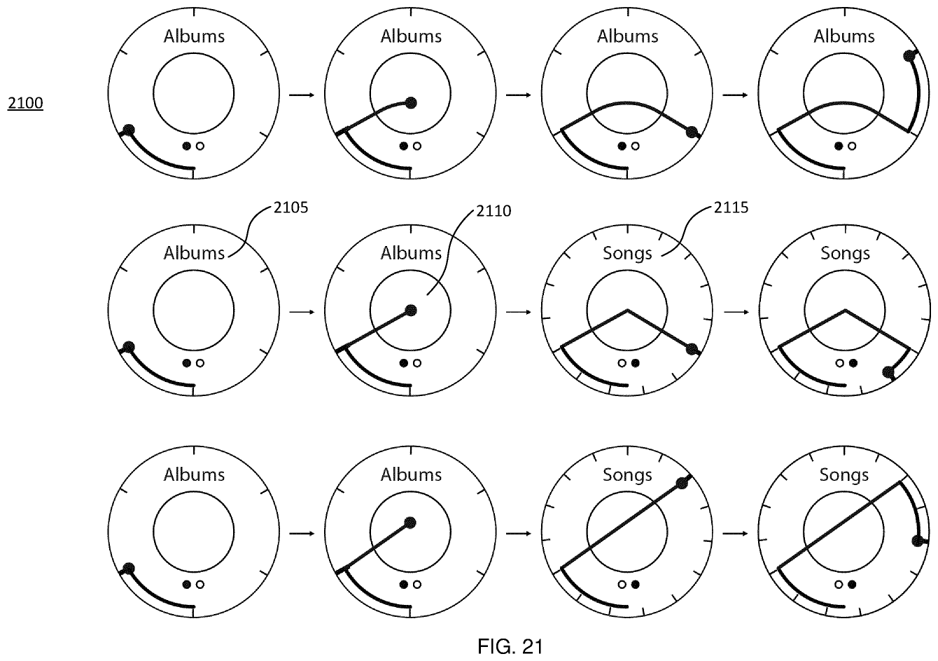

FIG. 21 shows an example user interface of a CS 2100, with three different usage patterns. A user adjusts a first parameter 2105 and traverses through a predetermined region 2110 of a fine-tune interface. The path traversed through the predetermined region may be analysed to determine its linearity. If the path traversed by a user is determined to be beyond a predetermined threshold of linearity, at least one parameter which is adjusted by the fine-tune interface may be changed to a second parameter 2115. However, if the path traversed by the user is determined to not be beyond a predetermined threshold of linearity, no changes may be made to at least one parameter which is currently being adjusted by the fine-tune interface. The user may then proceed to continue to adjust the first parameter. When a user enters and exits a predetermined region of the fine-tune interface at least one segment of the path traversed by the user is analysed to determine the linearity of the path. If at least one segment of the path is beyond a predetermined threshold of linearity, then at least one parameter which is adjusted by the fine-tune interface may be changed.

Optionally, when a user exits a predetermined region for changing the parameter which is adjusted by the fine-tune interface without changing the parameter, it does not result in a parameter being adjusted. It may instead result in a change of at least one value which is used in determining if a user has adjusted a parameter using the fine-tine interface.

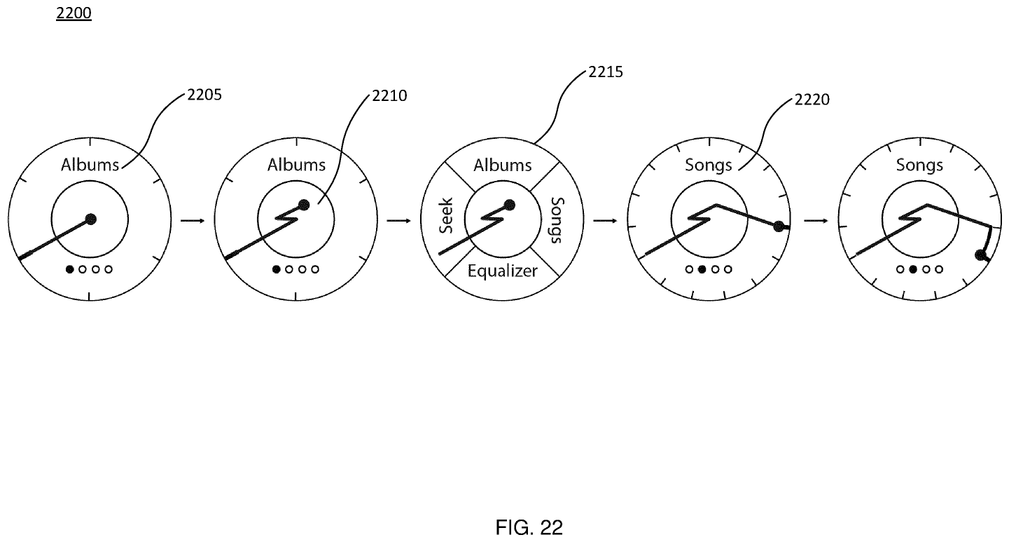

FIG. 22 shows an example user interface of a CS 2200. In this example, a user adjusts a first parameter 2205, enters a predetermined region 2210 of a fine-tune interface and performs a gesture. This causes a menu 2215 to appear, and the user then selects a menu item and proceeds to adjust a second parameter 2220. The second parameter 2220 corresponds with the selected menu item using the fine-tune interface. This process can be repeated to adjust multiple parameters. A gesture performed within the predetermined region 2210 of the fine-tune interface may be used to determine at least one menu item which may be displayed in a menu which appears as a result of the user performing a gesture within a predetermined region within the fine-tune interface.

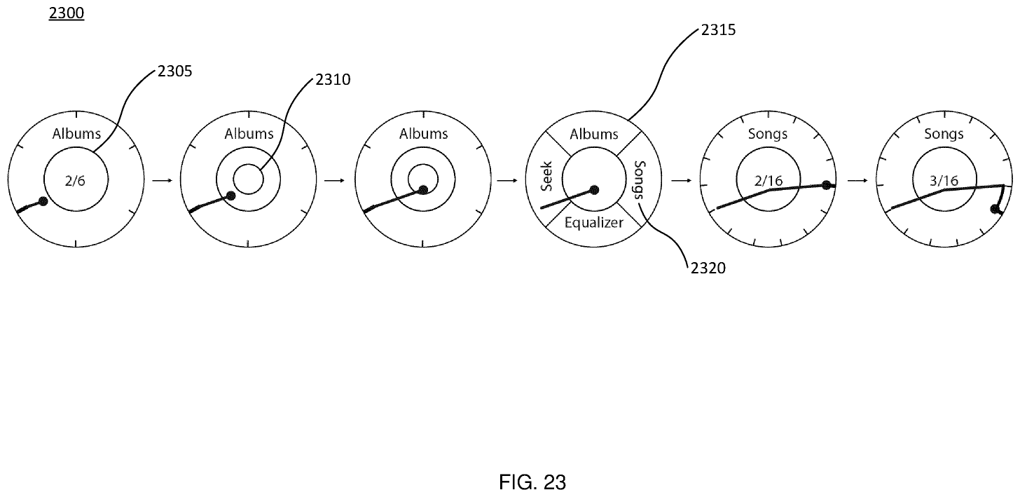

FIG. 23 shows an example user interface of a CS 2300. In this example, a user interacts with a predetermined region 2305 of a fine-tune interface, and an indication of a second predetermined region 2310 is indicated to the user. If the user interacts with the second predetermined region 2310, the user is then presented with a menu of options 2315. In this example, the user interacts with the second predetermined region 2310 and proceeds to select a parameter 2320 to be adjusted from the menu and then continues to adjust the newly selected parameter 2320.

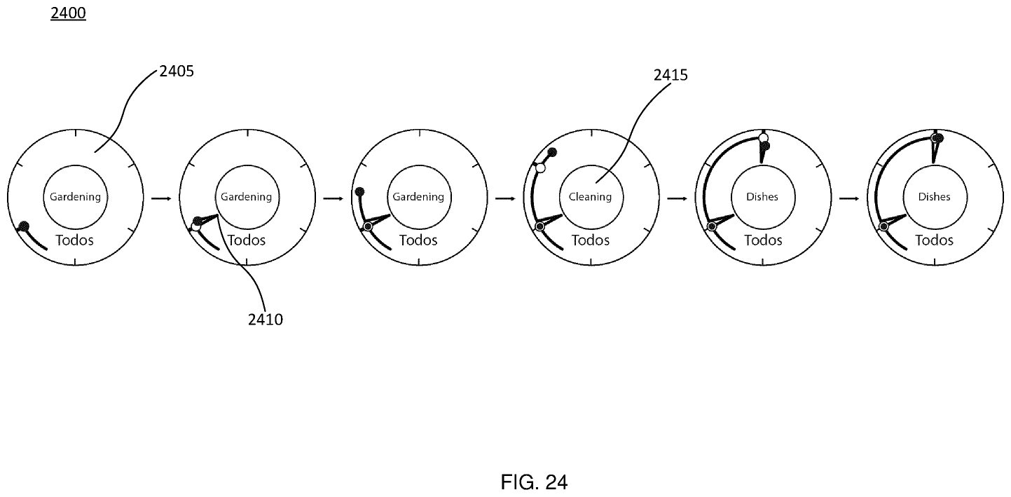

FIG. 24 shows an example user interface of a CS 2400. In this example, a user interacts with a fine-tune interface, adjusts a parameter 2405, and toggles the selection state of a parameter increment by performing an action or gesture 2410. The user then proceeds to explore the increments within the parameter 2405 and toggle the selection state of a second parameter increment 2415. The selection state of parameter increments may be indicated to the user.

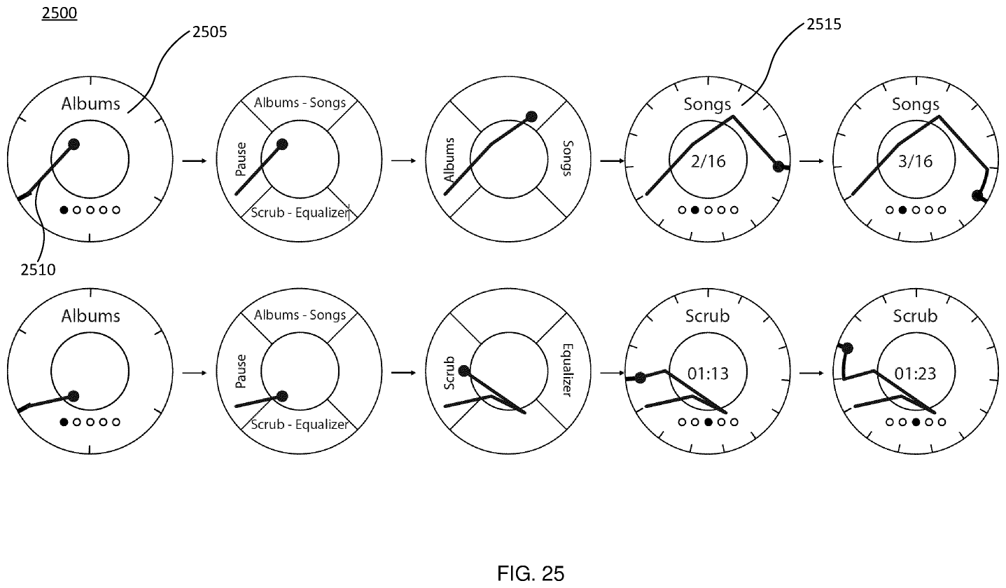

FIG. 25 shows an example user interface of a CS 2500. In this example, a user adjusts a first parameter 2505, and performs an action or gesture 2510 which results in a menu being displayed. The displayed menu presents to the user at least one menu group item which indicates the contents of that menu group item and indicates to the user the location within the menu where at least one menu item will be placed if the menu group item is selected by a user. A user selects a menu group item and the corresponding menu items are displayed within the menu in their indicated positions. A user selects a menu item and proceeds to adjust a second parameter 2515 which corresponds with the selected menu item using the fine-tune interface. This process can be repeated to adjust multiple parameters. This process allows a user to anticipate the structure of deeper layers of the menu without exploring them. A user is able to view more of the menu items within the menu as more menu items can be indicated within a layer of the menu system. Menu item groups can be placed and their contents can be indicated to a user on the vertical menu slots. This helps prevent the scenario where a user selects a menu group item on the left side of the menu using their right finger on a touch screen, which would result in a user's finger occluding their view of the menu items which were updated as a result of the user selecting a menu group item.

According to an aspect, there is provided an adjuster of a first quantity, that when an action is performed changes to adjust a second quantity. Optionally, the action is a gesture. Optionally, when the gesture a menu is displayed that allows the user to select a second quantity that the adjuster adjusts. Optionally, the menu can be navigated as a continuation of the adjustment movement, to allow the user to select a second quantity that the adjuster adjusts. Optionally, the adjuster is constrained to a space that adjusts a first quantity. When a gesture is performed outside that constrained space, a menu is displayed that can be navigated as a continuation of the adjustment movement, to allow the user to select a second quantity that the adjuster adjusts. Optionally, when a gesture is performed outside that constrained space an exit position of that menu allows the user to select a second quantity that the adjuster adjusts, and continuing the gesture performs adjustment.

Any range or device value given herein may be extended or altered without losing the effect sought, as will be apparent to the skilled person.

It will be understood that the benefits and advantages described above may relate to one example or may relate to several examples. The examples are not limited to those that solve any or all of the stated problems or those that have any or all of the stated benefits and advantages.

Any reference to “an” item refers to one or more of those items. The term “comprising” is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred example is given by way of example only and that various modifications may be made by those skilled in the art. Although various examples have been described above with a certain degree of particularity, or with reference to one or more individual examples, those skilled in the art could make numerous alterations to the disclosed examples without departing from the scope of this disclosure.

1. (canceled)

2. A computer-implemented method for navigating through a menu, the method comprising:
receiving a gesture input from a user; and
repurposing at least a portion of the first layer of the menu with one or more subsequent layers of the menu according to the received input, wherein the one or more subsequent layers of the menu comprise a fine-tuning interface;
receiving a continuation of the gesture input from the user,
selecting a point in the fine-tuning interface; and
executing a function based on the point selected in the fine-tuning interface.

3. The method of claim 2, wherein the gesture input comprises a continuous non-linear gesture path.

4-12. (canceled)

13. The method of claim 2, further comprising the step of providing haptic feedback and/or audio feedback in response to the gesture input, wherein the feedback allows a user to perform gestures and receive information without attending to the input, or the feedback indicates the phase of the gesture that is being performed, or the feedback indicates an identifiable aspect of the gesture, or the feedback indicates the partial or complete response to the gesture.

14. The method of claim 2, further comprising the step of monitoring the speed and/or acceleration of the gesture input, and modifying the first layer and/or one or more subsequent layers of the menu in response to the monitored speed and/or acceleration.

15-23. (canceled)

24. An apparatus comprising:
at least one processor;
a memory storing instructions that, when executed by the at least one processor, perform a method comprising:
generating a first layer of the menu on a graphical user interface;
receiving a gesture input from a user comprising a continuous non-linear gesture path, the gesture input travelling from a first input region to one or more subsequent input regions;
replacing at least a portion of the first layer of the menu with one or more subsequent layers of the menu on the graphical user interface according to the received input, wherein the one or more subsequent layers of the menu comprise a fine-tuning interface;
receiving a continuation of the gesture input from the user, such that the gesture input and the continuation of the gesture input is a single motion,
selecting a point in the fine-tuning interface; and
executing a function based on the point selected in the fine-tuning interface.

25. A computer-implemented method comprising receiving at a processor, a single gesture that performs multiple purposes, the single gesture being divided by an aspect, the aspect being temporal, spatial or positional, into distinct parts, wherein the distinct parts of the single gesture form distinct instructions.

26. The method of claim 25, wherein one or more parts of the gesture activates receptiveness of the processor to accept gestures.

27. The method of claim 26, wherein an activation portion of the gesture is chosen to be distinct from other input activity that a user regularly performs, thereby reducing the chance that the activation portion of the gesture would be inadvertently performed in the course of normal use, inadvertently causing a control to be activated, and wherein the gesture is locally or globally distinct, such that there is no ambiguity about the user's intent.

28. The method of claim 25, wherein the gesture is split such that one or more parts of the gesture selects a specific control or group of controls.

29. The method of claim 28, wherein the part of the gesture that selects is the position at the completion of the activation portions of the gesture, such that ending an activation phase in different locations produces a different selection.

30. The method of claim 25 wherein one or more parts of the gesture adjusts selected controls.

31. The method of claim 30, wherein the one or more parts of the gesture that adjusts the selected controls use one or more distinct features of the gesture to modify the status of the activated control.

32. The method of claim 25 wherein a portion of the gesture exceeds a threshold before it is accepted.

33. The method of claim 25 wherein the gesture is divided into parts by one or more defined zones of the input region.

34. The method of claim 25, wherein performance of the gesture is facilitated by a graphical user interface and the graphical user interface changes according to an interpreted phase of the gesture so that the graphical user interface provides a guide as to how the gesture for that phase may be performed.

35. The method of claim 25, further comprising providing haptic feedback and/or audio feedback in response to the gesture input, wherein the feedback allows a user to perform gestures and receive information without attending to the input, or the feedback indicates a phase of the gesture that is being performed, or the feedback indicates another identifiable aspect of the gesture, or the feedback indicates a partial or complete response to the gesture.

36. The method of claim 25, further comprising monitoring the speed and/or acceleration of the gesture input, and modifying a first layer and/or one or more subsequent layers of a menu in response to the monitored speed and/or acceleration.
